(19) United States
(12) Patent Application Publication
(10) Pub. No.: US 2026/0287712 A1
(43) Pub. Date: Sep. 24, 2026

(54) SYNTHETIC APERTURE RADAR CORNER REFLECTOR

(71) Applicant: VerQuin LLC, San Clemente, CA (US)

(72) Inventor: Christian Walls, San Clemente, CA (US)

(21) Appl. No.: 19/691,274

(22) Filed: May 28, 2026

Related U.S. Application Data
(63) Continuation-in-part of application No. 19/652,779, filed on Apr. 20, 2026.
Application No. 19/652,779 is a continuation of application No. 18/459,001, filed on Aug. 30, 2023, now Pat. No. 12,607,711.
(60) Provisional application No. 63/402,194, filed on Aug. 30, 2022.

(51) Int. Cl. G01S 7/03; G01S 7/00; G01S 7/40; G01S 13/88

(52) U.S. Cl. CPC G01S 7/032; G01S 7/003; G01S 7/4017; G01S 13/885

(57) ABSTRACT

Aspects of the disclosed technology provide solutions for improving satellite calibration reflectors and in particular, for improving performance of corner reflectors used for calibrating synthetic aperture radar (SAR) satellites. A process of the disclosed technology can include steps for constructing a satellite ground reflector comprising coupling a braced foundation to a trihedral reflector, wherein the trihedral reflector comprises a plurality of vertices and coupling two or more survey pins to two or more of the vertices, wherein each of the two or more survey pins are configured to facilitate one or more measurements of the satellite ground reflector. A process of the disclosed technology can also include steps for precise measuring and precise timing by placing GNSS instrumentation at or near the vertices of the satellite ground reflector.

### 1. RELATED APPLICATION

This application is a Continuation-in-Part of U.S. application Ser. No. 19/652,779, filed Apr. 20, 2026, which is a Continuation of U.S. application Ser. No. 18/459,001, filed on Aug. 30, 2023, now U.S. Pat. No. 12,607,711, which claims the benefit of U.S. Provisional Application No. 63/402,194, filed Aug. 30, 2022, which are hereby incorporated by reference in their entireties.

### BACKGROUND

### 2. Technical Field

The present disclosure generally relates to solutions for improving satellite calibration reflectors and in particular, for improving performance of corner reflectors used for calibrating synthetic aperture radar (SAR) satellites.

### 3. Introduction

Synthetic Aperture Radar (SAR) satellites commonly use corner reflectors for a variety of uses related to calibration and validation of the SAR data (the reflected radar). Collected SAR data can be used for a wide variety of applications including but not limited to the monitoring of: vegetation, soil moisture, tundra motion, glacial melting, sea level rise, atmospheric modeling, magma inflation, strain accumulation on faults, and coseismic and post seismic displacement during and after earthquakes, and the like. Corner reflectors further serve as precision radar targets in military and intelligence, surveillance, and reconnaissance (ISR) test range applications, where a geodetically stable, known-geometry reflector of verified position and orientation supports the performance evaluation of airborne and space-based radar imaging systems under controlled conditions. In some aspects, corner reflectors may also be adapted for deployment in space-adjacent or lunar environments to support calibration and validation of radar systems operating in orbit around or in proximity to extraterrestrial bodies.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates an example of a Synthetic Aperture Radar (SAR) corner reflector, according to some examples of the present disclosure.

FIG. 2 illustrates an example of a SAR corner reflector with a rotational base, according to some examples of the present disclosure.

FIG. 3 illustrates an example of a braced monumentation system, according to some according to some examples of the present disclosure.

FIG. 4 illustrates an example of a vertex gusset for use with a SAR corner reflector according to some examples of the present disclosure.

FIG. 5 illustrates an example of a survey ground control system, according to some according to some examples of the present disclosure.

FIG. 6 illustrates an example of a survey pin, according to some examples of the present disclosure.

FIG. 7 illustrates an example of a continuously operating Global Navigation Satellite System (GNSS) system, according to some examples of the present disclosure.

FIG. 8A illustrates an example environment of a corner reflector for various applications, according to some examples of the present disclosure.

FIG. 8B illustrates another example environment of a corner reflector for various applications, according to some examples of the present disclosure.

FIG. 9 illustrates an example process for constructing a satellite ground reflector, according to some examples of the present disclosure.

FIG. 10 illustrates an example block diagram of an actuated SAR corner reflector system, according to some examples of the present disclosure.

FIGS. 11A-I illustrate various views and mounting configurations of an example actuated SAR corner reflector, according to some aspects of the present disclosure.

FIG. 12 illustrates an example process for performing self-directed alignment, according to some examples of the present disclosure.

FIG. 13 illustrates an example process for performing closed-loop stability maintenance of a corner reflector during an observation window, according to some examples of the present disclosure.

FIG. 14 illustrates an example computer system that can be used for implementing various aspects of the present disclosure.

In the drawings, like reference numbers generally indicate identical or similar elements. Additionally, generally, the left-most digit(s) of a reference number identifies the drawing in which the reference number first appears.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form to avoid obscuring the concepts of the subject technology.

In some aspects, Synthetic Aperture Radar (SAR) satellites are commonly used for ground mapping as well as target identification. By way of example, the general principle behind SAR is to obtain high resolution images by coherently combining amplitude and phase information of separate radar returns from a plurality of sequentially transmitted pulses from a relatively small antenna on a moving platform. The returns from the pulses, when coherently combined and processed, may result in image quality comparable to a longer antenna, corresponding approximately to the synthetic “length” traveled by the antenna during the acquisition of the image.

A corner reflector (also reflector, satellite ground reflector) can be a passive device used to reflect radio waves back towards the emission source (e.g., satellite). Hence, a corner reflector may be a useful device for radar system calibration. In some instances, a corner reflector can consist of mutually intersected perpendicular plates. The corner reflectors can be used to generate a particularly strong radar echo from objects that would otherwise have only a very low effective Radar Cross Section (RCS). A typical corner reflector may consist of two or three electrically conductive surfaces that are mounted crosswise (e.g., at an angle of exactly 90 degrees). Incoming electromagnetic waves may be backscattered by multiple reflections accurately in the direction from which they came. Thus, even small objects (e.g., with a small RCS) can yield a sufficiently strong echo. In some instances, the larger a corner reflector is, the more energy may be reflected. By way of example, trihedral corner reflectors may be the preferred canonical target for SAR performance evaluation for many radar developments programs.

Corner reflectors may be used in areas with low correlation or high decorrelation. For example, in agriculture farms with grassy areas that change in height repeatedly and very often (e.g., an area of high decorrelation). In another example, corner reflectors can be used as fixed reference points for areas of high decorrelation (e.g., such as an area with a lot of trees) by serving as a marker that can be tied into a geospatial reference frame. Those skilled in the art will appreciate that other applications are contemplated.

Conventional corner reflectors, which may have unstable foundations, often move, or change position over time. These shifts in location (or reflector pose) may cause problems for long term calibration and validation. For example, the calibration and validation of active aerial Light Detection and Ranging (LiDAR) and satellite radar platforms may utilize a corner reflector to maintain a stable position. Accordingly, it would be beneficial to develop a solution of a corner reflector with a stable platform along and improved accuracy and precision of repeat ground-based survey measurements.

In some examples, a conventional corner reflector may be used as a long-term geodetic reference point across multiple satellite passes, satellite missions, frequency bands, and/or observation epochs. For example, a conventional corner reflector may be configured to maintain a known reflector pose relative to a spatial reference frame while also being oriented toward different look directions associated with different SAR satellites or acquisition geometries. In some cases, manually adjusting or confirming an alignment state of the conventional corner reflector for different observation windows may involve additional field activity, may introduce variability between adjustments, and/or may be difficult to perform with sufficient repeatability across multiple observation windows. Moreover, environmental conditions, ground movement, wind loading, vibration, settlement, thermal cycling, frost heave, subsidence, tectonic movement, tampering, and/or other disturbances may alter the position, orientation, or stability of the conventional corner reflector between or during observation epochs. Such changes, and the difficulty of documenting them in real time, may reduce confidence that radar returns from the conventional corner reflector correspond to a stable and accurately documented geodetic reference condition, and may give rise to further challenges in capturing and communicating the state of the conventional corner reflector to downstream calibration, validation, or processing systems.

Moreover, technical challenges may arise when reflector state information, such as, without limitation, one or more of the position, orientation, alignment state, stability condition, disturbance history, and other operating-condition characteristics of the conventional corner reflector, is not captured, synchronized, or communicated in a form that can be used by downstream calibration, validation, or processing systems. For example, even where a conventional corner reflector is surveyed or positioned with high accuracy at one time, the conventional corner reflector may not provide a contemporaneous machine-readable record of its reflector state information for a given satellite pass. As a result, downstream systems may lack sufficient information to determine whether a particular radar return was generated while the conventional corner reflector was aligned, stable, displaced, disturbed, or otherwise within an acceptable operating condition. These challenges may be amplified for multi-mission or multi-band calibration operations, where a conventional corner reflector may be configured to support different satellites, different look directions, different pass schedules, and/or long-term time-series comparisons.

Furthermore, technical challenges may arise for SAR acquisition modes in which a target ground area is illuminated for an extended dwell period (e.g., an amount of time during which a SAR satellite, radar beam, sensor, or other radar platform continues to illuminate, observe, or otherwise collect radar return information from the same target ground area, ground spot, scene, or region of interest). In some cases, such extended dwell operating modes may be used to increase synthetic aperture length, improve azimuth resolution, support higher-resolution imaging, and/or support other advanced SAR data products. However, during such an extended dwell period, the line-of-sight geometry between the SAR satellite and a ground-based reflector may change continuously as the satellite moves along its orbital path. A conventional corner reflector that is fixed, manually positioned, or aligned to a single pointing direction before acquisition may not maintain an optimal boresight alignment or radar cross-section relative to the satellite throughout the extended dwell period. Moreover, conventional approaches may not generate contemporaneous, time-indexed documentation of the reflector's position, orientation, alignment state, stability condition, and/or pointing error at multiple epochs during the extended dwell period. As a result, downstream SAR calibration, validation, or processing systems may lack information sufficient to determine whether different portions of an extended dwell SAR acquisition were obtained while the reflector was properly aligned, stable, and within an acceptable operating condition.

Solutions are provided herein for a corner reflector that maintains a stable position over time. By way of example, a VerQuin corner reflector can provide a durable and geodetically stable radar reflector that can maintain a stable position over time. The reinforced custom design of the VerQuin corner reflector may enable survey grade (e.g., ≤±2 cm orthometric height) positioning using real-time kinematic surveying or geodetic grade (≤±4 mm orthometric height) using laser techniques for calibration and validation of active aerial LiDAR and space-based satellite radar platforms to ground-based positioning measurements. Strategically designed, machined, and mounted survey pins (also Funderpins) can create individual subnetworks of survey points within each reflector or as a network of reflectors and may allow the incorporation of a variety of direct and indirect measurement techniques including, but not limited to, static or real-time GNSS (Global Navigation Satellite Systems), EDM (Electronic Distance Measurement or total station), offsets, and least-squares adjustments.

In some examples, Funderpins may be positioned at the vertices of the trihedral reflector for monitoring orientation (e.g., pitch, roll, yaw), deformation, and elevation change within any desired spatial reference frame. Additional stability and control of pitch, roll, and yaw can be achieved by the leveling and azimuthal control system. For continuous epoch-by-epoch measurements, position time-series development, and remote monitoring, a continuous GNSS (cGNSS) antenna mount can allow for individual use or may be tied directly into the machined offsets of each reflector's respective subnetwork of survey points to perform least squares adjustments of any reference point(s) of the reflector. In some cases, cGNSS may provide three-dimensional (3D) measurements with an accuracy up to several millimeters and can offer daily or sub-daily resolution. In some instances, cGNSS may include the permanent installation of an antenna in a fixed, specific location.

In some aspects, one or more sensing components, one or more computation components, and/or one or more actuation components may be incorporated with the corner reflector to facilitate one or more geodetic operations. As described herein, geodetic operations may include, without limitation, calibration operations, validation operations, monitoring operations, alignment operations, stability-maintenance operations, state-documentation operations, and/or combinations thereof. For example, such geodetic operations may include self-directed alignment of the corner reflector toward a target satellite line-of-sight for a given observation window, closed-loop maintenance of a commanded pointing geometry based at least in part on detected movement, tilt, vibration, disturbance, and/or other changes in reflector state, generation of contemporaneous reflector state information indicating a geodetic position, orientation, alignment state, stability condition, disturbance history, and/or other operating-condition characteristic of the corner reflector for a corresponding calibration epoch or validation epoch, and/or continuous monitoring of the corner reflector for unauthorized movement, tampering, structural compromise, or other changes in reflector state that may affect an integrity of the calibration and validation record. In this way, the corner reflector may reduce field activity associated with manually adjusting or confirming alignment for different observation windows, may improve repeatability of reflector alignment across multiple satellite passes, missions, frequency bands, and/or observation epochs, and/or may provide downstream SAR calibration, validation, or processing systems with information usable to evaluate whether radar returns correspond to a stable and accurately documented geodetic reference condition.

In some cases, the described corner reflector maybe adapted for deployment in space-adjacent or lunar environments by incorporating thermal cycling tolerance across the expected operational temperature range, vacuum compatibility of materials and sealing, and radiation tolerance of electronic components. In some examples, the described corner reflector may be configured for use in military test ranges for weapons system verification or Intelligence, Surveillance, and Reconnaissance (ISR) performance benchmarking, where it may serve as a precision, geodetically referenced radar target with known and certified geometry, position, and orientation.

In some instances, the described corner reflector may support an extended dwell operating mode. As described herein, an extended dwell operating mode may involve a dwell period during which a SAR satellite, radar beam, sensor, or other radar platform continues to illuminate, observe, or otherwise collect radar return information from the same target ground area, ground spot, scene, or region of interest. During such a dwell period, the described corner reflector may dynamically update a reflector pose, pointing geometry, alignment state, and/or other reflector state characteristic based at least in part on satellite pass information, orbital ephemeris data, real-time geodetic position information, sensor data, actuator feedback, and/or fused data described herein. For example, the corner reflector may continuously or periodically adjust an azimuth, elevation, tilt, boresight direction, and/or aperture orientation of the corner reflector to maintain alignment with a changing line-of-sight geometry of a target satellite during the dwell period. In this way, the corner reflector may maintain an improved radar cross-section relative to the target satellite over multiple epochs of an extended dwell acquisition and may generate contemporaneous reflector state information usable to document the position, orientation, alignment state, stability condition, pointing error, and/or another operating-condition characteristic of the corner reflector during the extended dwell operating mode.

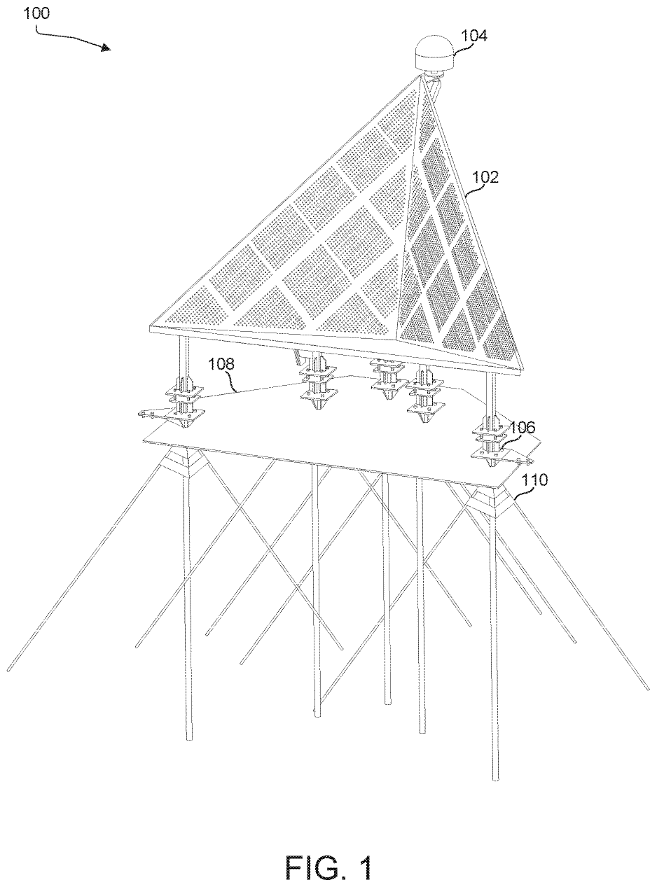

FIG. 1 illustrates an example of a SAR corner reflector 100, according to some aspects of the disclosed technology. By way of example, SAR corner reflector 100 can be a VerQuin corner reflector. The corner reflector 100 may include a trihedral reflector 102 comprising three mutually perpendicular, intersecting flat surfaces forming a corner. In some aspects, when a radar wave (e.g., from a SAR satellite) hits one of the surfaces of trihedral reflector 102, the wave can reflect onto the second surface and then onto the third surface before being sent back towards the radar. The multi-reflection among the surfaces of trihedral reflector 102 can enable a strong return signal. In SAR applications, corner reflector 100 with trihedral reflector 102 may be used in applications including, but not limited to, calibration targets (e.g., calibrate the radar system and validate perform), ground control points (e.g., georeferencing or rectifying SAR imagery), and reference points (e.g., for scientific experiments).

The SAR corner reflector 100 may be mounted to a surface or foundation 108 (e.g., ground, ice or snow, solid rock, concrete, metal, etc.) via one or more stantions 106 (also support structures or rigid structures) that may provide support between trihedral reflector 102 and surface or foundation 108. The one or more stantions 106 may be coupled to a monument (also monumentation) system 110 (e.g., a geodetic grade monument or braced foundation), where monument system 110 can be located beneath surface or foundation 108. In some aspects, monument system 110 may be a braced foundation or structure that can provide geodetic grade stability to SAR corner reflector 100.

In some cases, one or more cGNSS receivers 104 may be attached to or near one or more of the vertices (or corners) of trihedral reflector 102. The cGNSS receiver 104 may add functionality to SAR corner reflector 100 by continuously recording position data (e.g., using GNSS systems such as GPS, GLONASS, Galileo, etc.) of SAR corner reflector 100. The cGNSS receiver 104 may collect position data over both short and long time durations. In some aspects, the position data from cGNSS receiver 104 may be compared with position data derived from radar which may facilitate calibration and validation of SAR corner reflector 100.

In addition to providing high-rate GNSS data, cGNSS receiver 104 can also provide two additional survey control points for further geometric control (e.g., one offset from the apex or top vertex of trihedral reflector 102 and one projected normally below the antenna reference point and geodetic reference point or cGNSS receiver 104).

The stantions 106 and monument system 110 may be fabricated from one or more types of metal including, but not limited to, stainless steel, carbon steel, galvanized steel, aluminum, copper, bronze, brass, gold, titanium, and cast iron. In some instances, stantions 106 and additional materials surrounding trihedral reflector 102 may be coated with a magnetic radar absorbent material (MagRAM) which can reduce radar reflections. By way of example, stantions 106 may be coated with MagRAM to minimize multipath radar reflections to ensure the primary radar reflection is from trihedral reflector 102. In some instances, MagRAM may coat or cover all satellite-facing surfaces that are not part of the aperture of SAR corner reflector 100.

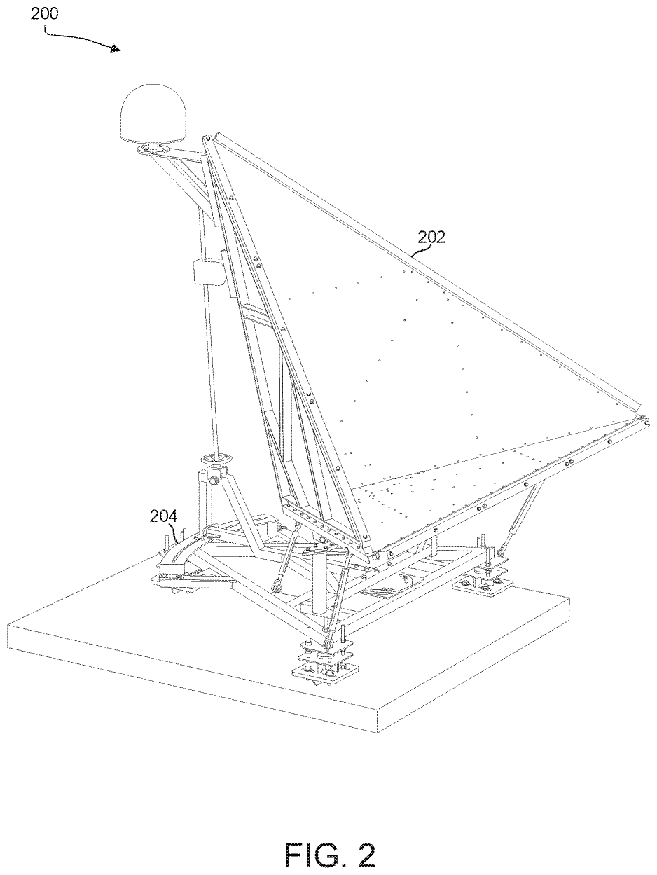

FIG. 2 illustrated an example of a SAR corner reflector 200 with a rotational base, according to some aspects of the disclosed technology. The SAR corner reflector 200 may be analogous to the example SAR corner reflector 100 illustrated in FIG. 1. The SAR corner reflector 200 may include a trihedral reflector 202 mounted on a rotational base 204 instead of a fixed foundation as illustrated in FIG. 1. The rotational base 204 may swivel in the azimuth direction. The rotational base 204 may provide fine tuning of SAR corner reflector 200 for communication with a satellite. The rotational base 204 may allow forward and back tilt of the corner reflector 200. The adjustable sub-assemblies of the rotational base 204 may allow leveling of the full assembly and may allow vertical height adjustments to test detectable limits in calibration and validation of the radar signal (e.g., received from the satellite).

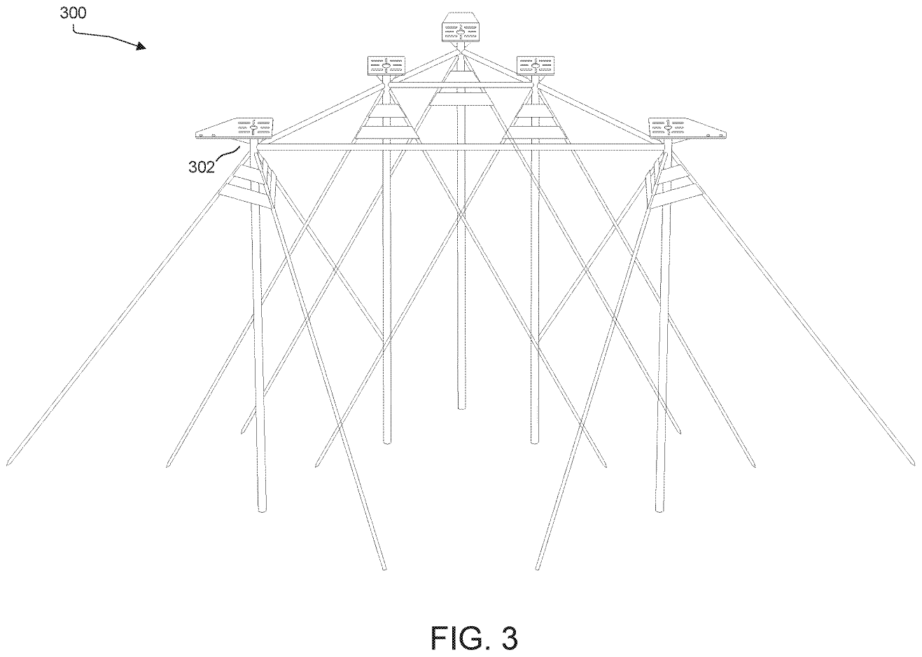

FIG. 3 illustrates an example of a braced monumentation system 300, according to some aspects of the disclosed technology. The braced monumentation system 300 (e.g., monument system 110 as illustrated in FIG. 1) may include one or more metal gussets 302 that can reinforce and connect components at an intersection (e.g., between the support structures of the SAR corner reflector and the braced monumentation system 300). By way of example, metal gussets 302 on both the internal and external intersection points may provide stable points at the vertex of the monument design (e.g., quad or quincunx monument design as illustrated in FIG. 3). In some cases, individual monuments may be linked or welded with cross pipes to make the entire suite of monuments a single rigid structure. The monuments may be drilled or epoxied directly into bedrock or driven into sediment with the upper portions encased in concrete (e.g., a concrete slab over the stainless-steel foundation).

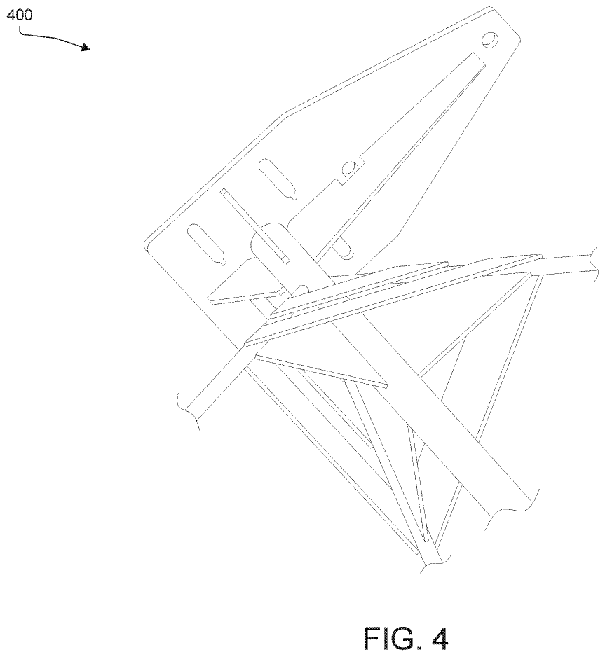

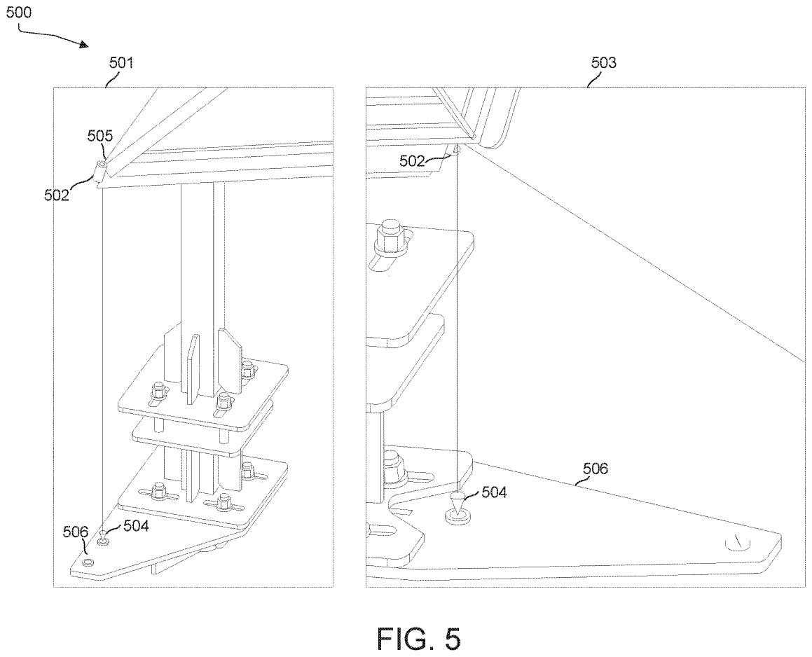

FIG. 4 illustrates an example of a vertex gusset 400 for use with a SAR corner reflector, according to some aspects of the disclosed technology. The vertex gusset 400 as illustrated in FIG. 4 can be the underside view of a metal gusset 300 (e.g., as illustrated in FIG. 3) located at a vertex of the monument system, such as the vertex location associated with the vertex of the trihedral reflector. In some cases, a plumb bob may be suspended (e.g., via a string or wire) from a Funderpin or survey pin at the vertex of a trihedral reflector over vertex gusset 400 for monitoring and measuring purposes (e.g., monitoring changes in position and/or orientation of the trihedral reflector or SAR corner reflector). The Funderpin and plumb bob assembly in association with vertex gusset 400 will be discussed in further detail in FIG. 5 below.

FIG. 5 illustrates an example of a survey ground control system 500, according to some aspects of the disclosed technology. A first perspective 501 and second perspective 503 illustrate a survey ground control system 500 with the vertex 505 (e.g., one of the three vertices) of a trihedral reflector with Funderpin 502 and associated plumb bob 504 hanging (e.g., via a string or wire) over vertex gusset 506 (e.g., vertex gusset 400 as illustrated in FIG. 4).

In some aspects, Funderpin 502 may be located at or near each corner or vertex 505 of a trihedral reflector and may provide a point that can be measured to and from in order to monitor changes in the position or orientation of the reflector. By way of example, the measurements from each of the Funderpins 502 may indicate changes in pitch, roll and yaw of the corner reflector (e.g., trihedral reflector portion of the corner reflector).

A plumb bob 504 attached to a Funderpin 502 can provide a vertical reference from each vertex 505 of the reflector and the ground. For example, the plumb bob 504 may hang over vertex gusset 506 such as a specific point designated on vertex gusset 506. If the specific point below plumb bob 504 shifts, this may indicate a change in position or orientation of the reflector. By way of example, real-time kinematic (RTK) or electronic distance measurements (EDM) of these points may allow the dimensions and orientation of the corner reflector to be tied to a local, regional, or global reference frame for refinement of calibration and validation of the SAR signals.

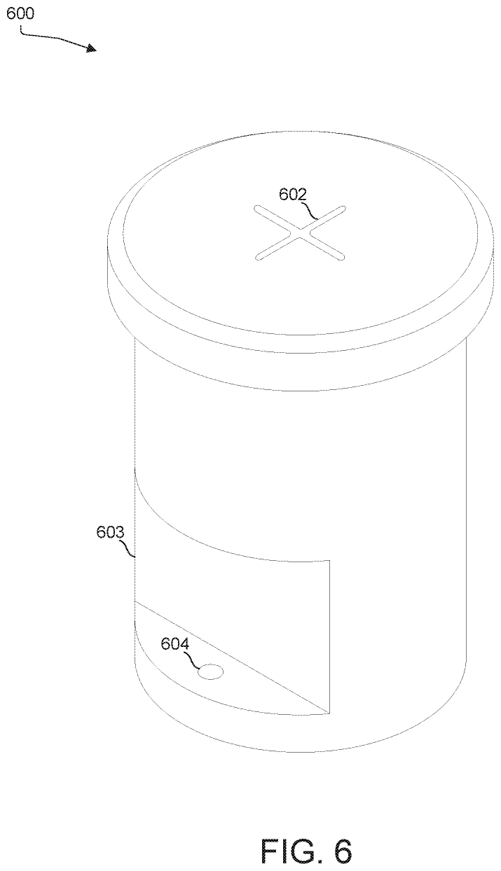

FIG. 6 illustrates an example of a survey pin 600, according to some aspects of the disclosed technology. The survey pin or Funderpin 600 may include a recess or region 602 for tool engagement (e.g., for inserting a survey spike of an optical EDM reflector or RTK rod). A slot 604 (or hole, aperture) may be used to attach or hang (e.g., via a wire, string, etc.) a plumb bob to Funderpin 600. As discussed above, one or more vertices of a corner reflector may include a Funderpin 600 for measurement of pitch, roll, and yaw of the corner reflector. The survey pin 600 may represent the vertices of the trihedral reflector. The Funderpin 600 may also include a cavity 603 (or recessed region) for facilitating the attachment of the plumb bob (e.g., a plumb bob line or wire or string through aperture 604) that may be in direct alignment with the survey pin 600 for a given angle of tilt of a trihedral reflector.

The region 602 of Funderpin 600 may include cross hatch grooves for visual and physical assistance with placement of precision measuring devices (e.g., assistance for surveyors for placement of the survey spike in the survey pin 600 which can be aided in its placement by observation of the cross hatch).

In some cases, a Funderpin 600 at each vertex of a corner reflector may allow for vector-based reconstruction of the trihedral planes for creating a scalable subnetwork of survey points for applications like planar orientation and deformation analyses and can be used as a larger network to perform least squares adjustments of campaign or continuous measurements. Centered on each rail of the reflector may include stanchion mounts for leveling and leaving surveying rods in a fixed position (e.g., rods can have either reflectors or GNSS for real-time kinematic analysis).

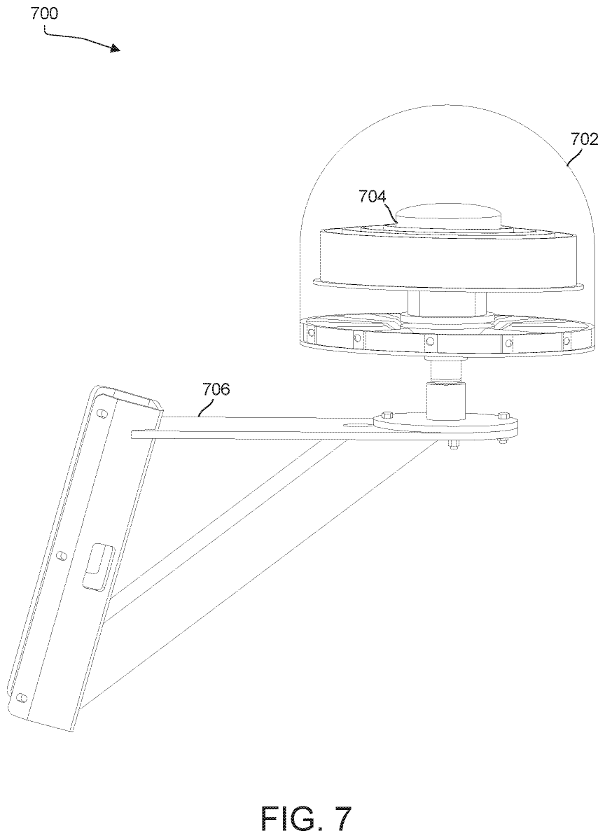

FIG. 7 illustrates an example of a continuously operating GNSS (cGNSS) system 700, according to some aspects of the disclosed technology. The cGNSS system 700 includes a radome 702 enclosing a high precision GNSS antenna and receiver 704 (e.g., to receive one or more GNSS satellite signals) that is attached to a mount 706. In some aspects, the GNSS antenna may be linked via coaxial cable to a high precision GNSS receiver (e.g., not illustrated) off the structure or may be an integrated GNSS antenna and receiver. As discussed above, one or more cGNSS systems 700 may be attached to or near one or more vertices of a corner reflector and provide additional positioning information with respect to the Funderpins and survey ground control system 500 as discussed in FIG. 5. For example, continuous operation of cGNSS system 700 may enable timing and positioning comparison of data between the radar satellite and GNSS constellation timed signals for refinement of calibration techniques.

In some instances, boosting the timing frequency (e.g., from 1 Hz. to 100 Hz.) of GNSS receiver 704 may provide enhanced temporal resolution, which may be beneficial for dynamic phenomena like space weather and ionospheric electron content fluctuations. In some cases, the GNSS antenna and receiver 704 timing for SAR applications may be strengthened by observing multiple satellite constellations (e.g., GPS and Galileo), integrating high-quality clocks (e.g., atomic clocks), and optimizing antenna placement to mitigate multipath effects and maximize satellite visibility.

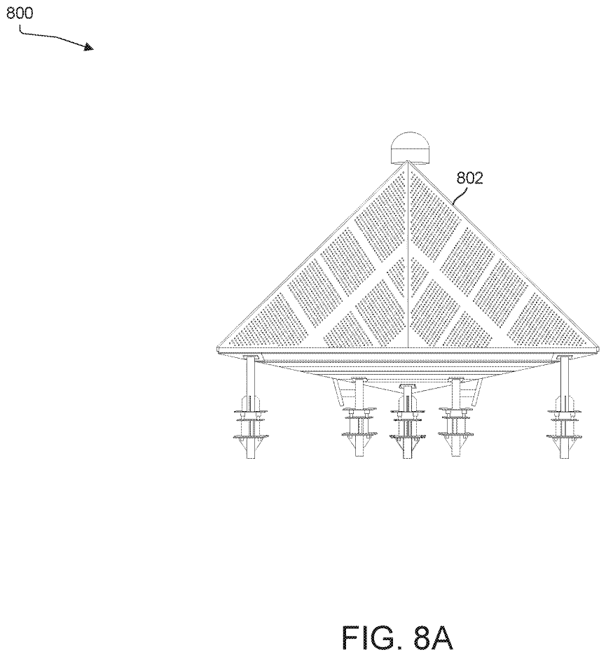

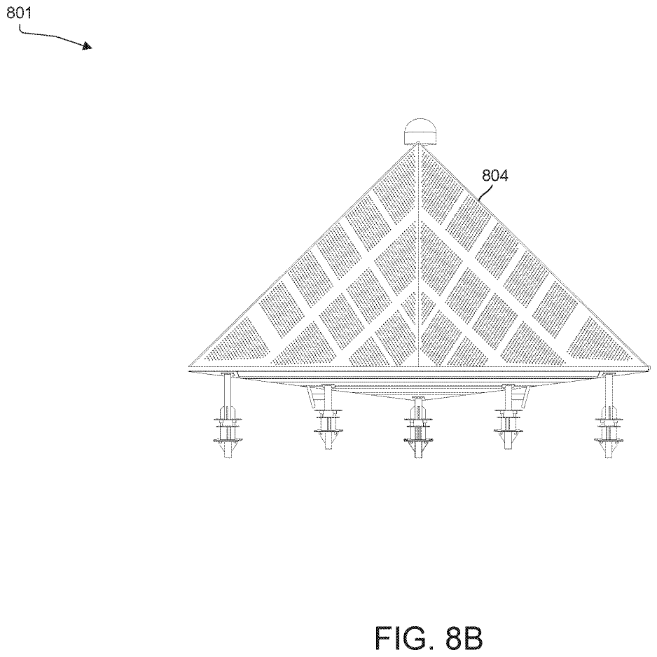

FIG. 8A illustrates an example environment 800 of a corner reflector for various applications, according to some aspects of the disclosed technology. A first corner reflector 802 may be used for SAR applications. FIG. 8B illustrates another example environment 801 of a corner reflector for various applications, according to some aspects of the disclosed technology. A second corner reflector 804 may be used for NASA-ISRO SAR (NISAR) applications. Those skilled in the art will appreciate additional applications for first corner reflector 802 and second corner reflector 804.

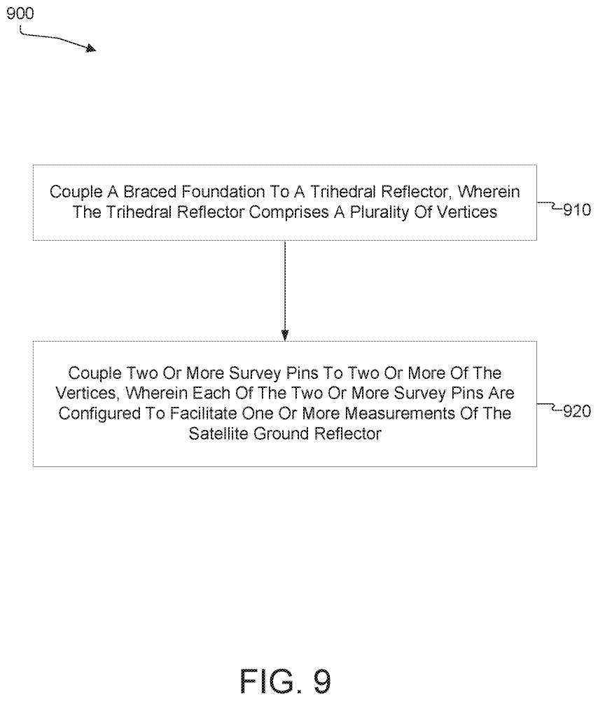

FIG. 9 illustrated an example process 900 for constructing a satellite ground reflector, according to some aspects of the disclosed technology. At step 910, process 900 includes coupling a braced foundation to a trihedral reflector, wherein the trihedral reflector comprises a plurality of vertices. For example, a trihedral reflector (e.g., trihedral reflector 102 as illustrated in FIG. 1) may include a plurality of vertices, such as three vertices. The trihedral reflector can be coupled or attached to a braced foundation (e.g., monument system 110 as illustrated in FIG. 1). The trihedral reflector may be attached to the braced foundation via support stantions or rigid structures (e.g., stantions 106 as illustrated in FIG. 1). The support stantions may be located on the underside of the bottom panel of the trihedral reflector.

At step 920, process 900 includes coupling two or more survey pins to two or more of the vertices, wherein each of the two or more survey pins are configured to facilitate one or more measurements of the satellite ground reflector. For example, two or more survey pins (e.g., Funderpin 600 as illustrated in FIG. 6) may be coupled or attached to two or more vertices of the trihedral reflector. The survey pins may facilitate measuring changes in position or orientation of the trihedral reflector (e.g., via RTK or EDM measurements, and or via the use of a plumb bob).

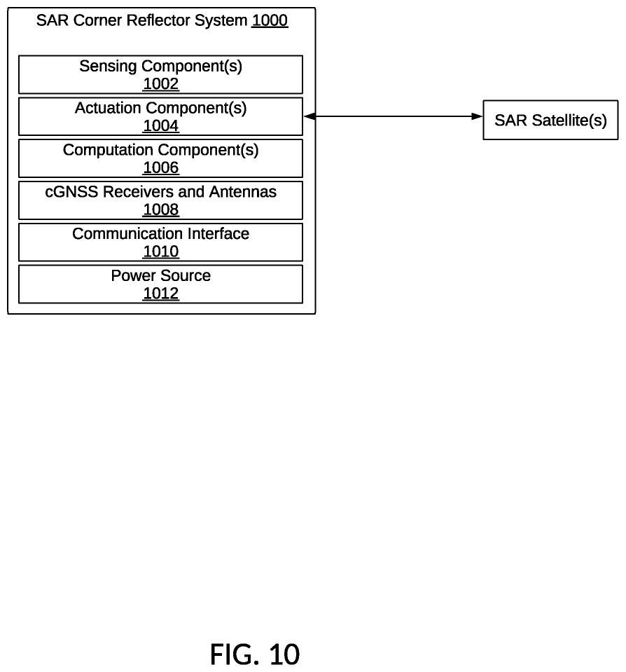

FIG. 10 illustrates an example actuated SAR corner reflector system 1000, in accordance with some aspects of the present disclosure. In some configurations, SAR corner reflector system 1000 may include a corner reflector, such as trihedral reflector 102 and/or trihedral reflector 202 described herein, supported by and/or coupled to a monument system, such as monument system 110 described herein. Moreover, SAR corner reflector system 1000 may include one or more sensing components 1002, one or more actuation components 1004, one or more computation components 1006, one or more cGNSS receivers and/or antennas 1008, a communication interface 1010, and/or a power source 1012. As described in further detail herein, one or more of these components may enable SAR corner reflector system 1000 to perform one or more geodetic operations, including, without limitation, self-directed alignment, closed-loop stability maintenance, reflector-state monitoring, generation or communication of reflector state information, tamper detection, and/or combinations thereof.

In some configurations, sensing components 1002 may include one or more sensors configured to generate sensor data indicative of a position, orientation, alignment state, stability condition, disturbance condition, movement condition, and/or other operating-condition characteristic of the SAR corner reflector system 1000. For example, the sensing components 1002 may include one or more inertial measurement units (IMUs), accelerometers, gyroscopes, inclinometers, tilt sensors, vibration sensors, strain sensors, displacement sensors, and/or combinations thereof.

By way of example, at least one IMU and/or at least one accelerometer may be coupled to the corner reflector. Moreover, the at least one IMU and/or at least one accelerometer may measure, in real time, orientation angles, tilt, vibration, and/or dynamic motion of the corner reflector. Based on the measurements, the at least one IMU and/or at least one accelerometer may generate sensor data associated with an orientation and/or motion of the corner reflector relative to a defined reference frame. As described herein, the orientation angles may include, for example, pitch, roll, yaw, azimuth, elevation, and/or another angular position of the corner reflector; the tilt may include, for example, a tilt magnitude and/or a tilt direction; the vibration may include, for example, a vibration frequency and/or a vibration amplitude; and/or the dynamic motion may include, for example, sudden displacement, impact, structural deformation, and/or another movement event associated with the corner reflector.

In some examples, the IMU may be a tactical-grade IMU, an industrial-grade MEMS IMU, or another inertial sensing device suitable for outdoor geodetic instrumentation. In some aspects, the multi-axis accelerometer of the IMU may comprise a three-axis MEMS accelerometer, and the multi-axis gyroscope of the IMU may comprise a three-axis MEMS gyroscope.

In some cases, sensing components 1002 may be mounted to, integrated with, embedded within, hard-mounted to, or otherwise coupled to the corner reflector, the monument system, actuation components 1004, and/or another structural portion of the SAR corner reflector system 1000. For example, sensing components 1002 may be positioned at or near an apex vertex of the trihedral reflector, where three reflector panels converge, on a non-aperture side of the trihedral reflector. Placement at or near the apex vertex may facilitate generation, by the sensing components 1002, of sensor data representative of a boresight and/or an overall orientation of the corner reflector during one or more geodetic operations. In another example, the sensing components 1002 may be positioned at or near a top portion of a spine of the trihedral reflector. Such positioning may provide improved sensitivity along a roll axis and/or may facilitate detection of differential flex, vibration, or motion between reflector panels.

In some aspects, one or more additional sensing components 1002 may be positioned at or near one or more leading vertices of the trihedral reflector. Such distributed sensing may be used, for example, in larger reflector configurations where sensor data from multiple portions of the corner reflector may be beneficial for determining reflector pose, reflector deformation, vibration, displacement, or another reflector state characteristic.

In some instances, sensing components 1002 may be hard-mounted directly to a rigid structural element of the corner reflector, such as an aluminum frame, a spine, a rigid panel support, and/or another rigid structural member. Hard-mounting sensing components 1002 to the rigid structural element may facilitate transmission of the orientation and motion of the corner reflector to sensing components 1002, which may improve accuracy of sensor data used to determine the reflector state information described herein. In some examples, mounting sensing components 1002 to a flexible or non-rigid surface of the corner reflector may be avoided to reduce measurement error associated with local flexure or movement that does not accurately represent the orientation or motion of the corner reflector as a whole.

In some cases, sensor data generated by sensing components 1002 may be used to determine a reflector pose and/or a change in the reflector pose before, during, or after an observation window, calibration epoch, validation epoch, satellite pass, and/or other geodetic operation. For example, the sensor data may indicate one or more of pitch, roll, yaw, azimuth, elevation, tilt, angular displacement, angular velocity, linear acceleration, vibration, oscillation, deformation, settlement, displacement, or other movement of the corner reflector relative to a reference frame. In this way, sensing components 1002 may provide contemporaneous information usable to determine whether the corner reflector is aligned, stable, displaced, disturbed, or otherwise within an acceptable operating condition for a corresponding geodetic operation.

In some aspects, sensing components 1002 may be used to generate sensor data associated with alignment, disturbance events, and/or integrity-related events for one or more geodetic operations. For instance, sensing components 1002 may generate sensor data indicative of movement, vibration, impact, tilt, acceleration, strain, displacement, structural deformation, unauthorized movement, tampering, structural compromise, and/or another change in a reflector state. Such sensor data may be used to determine whether such event has occurred and whether it may affect an alignment state, integrity, reliability, repeatability, and/or documentation of a calibration operation, validation operation, monitoring operation, alignment operation, stability-maintenance operation, state-documentation operation, and/or another geodetic operation. In some examples, sensor data generated by sensing components 1002 may be used, for example, without limitation, to determine reflector state information, control actuation components 1004, generate a stability or disturbance metric, generate a tamper detection record, and/or generate contemporaneous state documentation for a corresponding observation window.

In some configurations, actuation components 1004 may include one or more mechanical, electromechanical, hydraulic, pneumatic, motorized, or otherwise controllable components configured to adjust, maintain, or otherwise control a position, orientation, alignment state, pointing geometry, and/or other reflector state characteristic of the SAR corner reflector system 1000 during one or more geodetic operations. For example, during a calibration operation, validation operation, monitoring operation, alignment operation, stability-maintenance operation, state-documentation operation, and/or another geodetic operation described herein, actuation components 1004 may adjust an azimuth angle, elevation angle, tilt angle, pitch angle, roll angle, yaw angle, height, leveling state, and/or another positional or angular characteristic of the corner reflector relative to a defined reference frame.

In some examples, actuation components 1004 may include one or more motors, rotary actuators, linear actuators, servo motors, stepper motors, geared drives, gear assemblies, worm drives, turntables, rotary stages, gimbals, tilt stages, leveling mechanisms, jacks, screw drives, lead screws, ball screws, encoders, position feedback sensors, brakes, locks, clutches, and/or combinations thereof. In some aspects, actuation components 1004 may be coupled to, integrated with, incorporated into, configured to replace, configured to supplement, or otherwise associated with a rotational base, a support frame, a reflector frame, the monument system, and/or another structural portion of the SAR corner reflector system 1000.

In some cases, actuation components 1004 may be operatively connected to the corner reflector to adjust a physical orientation of the corner reflector during one or more geodetic operations. Moreover, actuation components 1004 may receive control information, as described herein. The control information may include one or more commands to move the corner reflector toward a target alignment state, maintain the corner reflector within an acceptable alignment tolerance, correct a detected pose deviation, reduce vibration or oscillation, compensate for disturbance-induced movement, and/or return the corner reflector to a baseline or commanded reflector pose. In some instances, the control information may be generated based at least in part on sensor data from sensing components 1002, position information from the one or more cGNSS receivers and/or antennas 1008, one or more measurements from a survey, one or more measurements from one or more Funderpins, satellite pass information, target line-of-sight information, baseline reflector state information, commanded reflector state information, and/or other information associated with a geodetic operation. In some aspects, such control information may be based at least in part on fused data, as described herein. Based on the control information, actuation components 1004 may reposition the corner reflector by adjusting one or more of azimuth, elevation, tilt, pitch, roll, yaw, height, leveling state, and/or another positional or angular characteristic to orient a reflector aperture toward a target position, such as a target satellite line-of-sight geometry, without manual intervention.

In some examples, actuation components 1004 may include an electronically actuated mount operatively connected to the trihedral reflector and configured to adjust at least one of an azimuth and a tilt of the corner reflector based on the control information, thereby enabling automated and repeatable pointing of the reflector aperture toward the target satellite line-of-sight geometry. For example, the electronically actuated mount may be coupled to, incorporated into, or configured to supplement rotational base 204 of the corner reflector. Alternatively, the electronically actuated mount may replace rotational base 204, such that the electronically actuated mount is mounted directly or indirectly to the monument system. In some configurations, the monument system may comprise a braced foundation permanently installed and tailored to local geology. Additionally, or alternatively, the monument system may comprise a transportable mounting system configured for field deployment, including helicopter sling-load transport.

In some cases, actuation components 1004 (e.g., the electronically actuated mount) may be configured to swivel the corner reflector in an azimuth direction and/or to provide forward and back tilt of the corner reflector, thereby enabling adjustment or fine tuning of the corner reflector for communication with a target satellite. In some aspects, actuation components 1004 may further enable leveling of the full assembly and/or vertical height adjustment of the corner reflector. For example, the electronically actuated mount may support single-axis actuation, multi-axis actuation, or a combination thereof. In a single-axis configuration, actuation components 1004 may adjust an azimuthal orientation of the corner reflector while another aspect of the monument system 110, a leveling mechanism, a fixed frame geometry, and/or a manually adjustable support structure maintains or defines one or more other orientation characteristics of the corner reflector. In a multi-axis configuration, actuation components 1004 may adjust two or more of azimuth, elevation, pitch, roll, yaw, tilt, height, or leveling state to support self-directed alignment, closed-loop stability maintenance, and/or another geodetic operation described herein.

In some instances, actuation components 1004 may comprise a heavy-duty pan-tilt unit powered by one or more motors with integrated position feedback sensors configured to provide angular position data associated with actuation components 1004. For example, the one or more motors may comprise one or more brushless DC motors, servo motors with encoder feedback, stepper motors with micro-stepping, direct-drive torque motors, high-torque motors, and/or combinations thereof. The integrated position feedback sensors may include, for example, one or more resolvers, encoders, position sensors, limit switches, torque sensors, current sensors, motor feedback circuits, redundant potentiometers, and/or other feedback devices configured to indicate a position, movement, load, torque, current draw, travel limit, locked state, unlocked state, or operational condition of actuation components 1004. In some aspects, actuation components 1004 may be rated to support a payload sufficient to accommodate a trihedral reflector operating in at least one of L-band, S-band, C-band, X-band, Ku-band, and P-band. In some aspects, actuation components 1004 may be rated to support a payload of at least 25 kilograms, at least 100 kilograms, at least 250 kilograms, at least 500 kilograms, at least 750 kilograms, or at least 1,000 kilograms, depending on a reflector size, frequency band, mounting configuration, deployment environment, construction material and/or wind-loading condition. For example, a smaller reflector may have a payload of approximately 25 kilograms, while a larger stainless-steel reflector configured for a polar, Antarctic, or other high-load deployment environment may have a payload of approximately 550 kilograms to approximately 750 kilograms. In some aspects, a reflector configured for P-band operation or another relatively large-aperture configuration may have a payload of approximately 1,000 kilograms or more.

In some aspects, the angular positioning accuracy, positioning resolution, and/or repeatability of actuation components 1004 may be within approximately 1 degree, within approximately 0.5 degrees, within approximately 0.1 degrees, within approximately 0.05 degrees, or another accuracy suitable for maintaining an acceptable radar cross-section of the corner reflector relative to peak alignment during geodetic operations. For example, actuation components 1004 may be configured to provide a positioning resolution of approximately 0.01 degrees or better and a repeatability of approximately 0.05 degrees or better. In some instances, sensor fusion using one or more IMUs, cGNSS receivers and/or antennas 1008, and/or other sensing components 1002 may support orientation accuracy of approximately 0.01 degrees or better. In some aspects, higher-resolution positioners, redundant potentiometers, additional feedback sensors, and/or other enhanced positioning components may provide positioning resolution, repeatability, and/or sensor-fused orientation accuracy within approximately 0.001 degrees to approximately 0.005 degrees, such as approximately 0.0025 degrees, for lunar, space-adjacent, laser reflectometry, or other high-precision applications.

In some examples, actuation components 1004 may support continuous azimuth rotation, with one or more operational limits configured to manage cable wrap, and a tilt range sufficient to cover look angles of one or more target satellites. In some aspects, actuation components 1004 may support a slew rate sufficient to enable rapid reorientation of the corner reflector between consecutive or conflicting satellite passes within an available time window and/or fine tracking of a changing line-of-sight geometry during an extended dwell operating mode. In some aspects, such slew rate may be approximately 0.001 degrees per second, approximately 0.005 degrees per second, approximately 0.01 degrees per second, approximately 0.1 degrees per second, approximately 1 degree per second, at least 5 degrees per second, and in some aspects approximately 20 degrees per second or more, or another rate suitable for the geodetic operation. In some aspects, the available time window for reorientation between consecutive or conflicting satellite passes may be determined by the orbital geometry and repeat-cycle parameters of the respective satellites, and the slew rate of actuation components 1004 may be selected to complete the reorientation within such available time window while allowing sufficient time for closed-loop alignment confirmation prior to the commencement of the subsequent observation window. Additionally, or alternatively, the slew rate may be selected to provide gradual, fine-scale, or continuous tracking adjustments during an observation window, including during a dwell period of an extended dwell operating mode. In some cases, feedback from actuation components 1004 may be used to verify that an actuation command was executed, determine whether an alignment adjustment was completed, detect actuator slippage or obstruction, and/or generate reflector state information for a corresponding observation window.

In some instances, actuation components 1004 may include one or more locking, braking, holding, or stabilizing mechanisms configured to maintain the corner reflector in a commanded alignment state after an adjustment. For example, the one or more locking, braking, holding, or stabilizing mechanisms may resist wind loading, vibration, mechanical backlash, drift, settlement-related movement, unauthorized movement, or another disturbance that may affect an alignment state or stability condition of the corner reflector. In some aspects, actuation components 1004 may be configured to transition between an unlocked or movable state for alignment adjustment and a locked or holding state for maintaining the commanded pointing geometry during a calibration operation, validation operation, monitoring operation, or other geodetic operation.

In some configurations, SAR corner reflector system 1000 may include one or more computation components 1006 (e.g., one or more controllers, processors, etc.) configured to process data, determine reflector state information, generate control information, coordinate one or more geodetic operations, and/or generate one or more outputs associated with the geodetic operations. For example, computation components 1006 may receive and/or process sensor data from sensing components 1002, position information from the one or more cGNSS receivers and/or antennas 1008, actuation feedback from actuation components 1004, one or more measurements from a survey, one or more measurements from one or more Funderpins, satellite pass information, target line-of-sight information, baseline reflector state information, commanded reflector state information, and/or other information associated with the SAR corner reflector system 1000. Based at least in part on such information, computation components 1006 may determine reflector state information, determine a change in reflector state information, generate control information for actuation components 1004, coordinate self-directed alignment, coordinate closed-loop stability maintenance, detect a disturbance event or integrity-related event, generate contemporaneous state documentation, and/or communicate information usable to document, record, or evaluate a geodetic state of the corner reflector during one or more geodetic operations.

In some examples, reflector state information may indicate one or more position, orientation, alignment, stability, disturbance, movement, actuation, and/or operating-condition characteristics of the corner reflector. For example, the reflector state information may indicate a reflector pose of the corner reflector, an alignment state of the corner reflector relative to a target satellite line-of-sight geometry, a stability condition of the corner reflector during an observation window, a disturbance condition associated with movement, vibration, impact, tilt, acceleration, strain, displacement, structural deformation, unauthorized movement, tampering, or structural compromise, an actuation state of actuation components 1004, a geodetic position of the corner reflector, a timestamp, and/or another temporal characteristic associated with one or more of the foregoing. As described herein, the reflector pose may include one or more of a position, azimuth, elevation, pitch, roll, yaw, tilt, height, leveling state, boresight direction, aperture orientation, and/or another spatial or angular characteristic of the corner reflector relative to a defined reference frame.

In some cases, computation components 1006 may determine the reflector state information based at least in part on fused data. As used herein, fused data may include data generated by combining, correlating, filtering, weighting, reconciling, or otherwise processing two or more data inputs associated with the SAR corner reflector system 1000 and/or a geodetic operation. For example, the fused data may be generated based at least in part on sensor data from sensing components 1002, position information from the one or more cGNSS receivers and/or antennas 1008, actuation feedback from actuation components 1004, one or more measurements from a survey, one or more measurements from one or more Funderpins, satellite pass information, target line-of-sight information, baseline reflector state information, commanded reflector state information, and/or other information associated with a geodetic operation. The fused data may allow computation components 1006 to determine reflector state information using multiple information sources rather than relying on a single measurement type.

In some instances, when generating the fused data and/or determining the reflector state information, computation components 1006 may process particular types of input data associated with different reference characteristics of the corner reflector, such as, without limitation, different positioning, orientation, and reference-frame characteristics of the corner reflector. For example, position information from the one or more cGNSS receivers and/or antennas 1008 may indicate continuous, three-dimensional absolute positioning of a cGNSS antenna phase center. Sensor data from sensing components 1002, such as an IMU and/or accelerometer, may indicate high-rate relative orientation, tilt, angular rate, vibration, acceleration, and/or motion information associated with the corner reflector. Orientation measurements derived from the one or more Funderpins may indicate changes in pitch, roll, yaw, and/or another orientation characteristic of the corner reflector. In some examples, the orientation measurements derived from the one or more Funderpins may be used to tie a geodetic state of the corner reflector to a local reference frame, regional reference frame, global reference frame, or combination thereof.

In some examples, when generating the fused data and/or determining the reflector state information, computation components 1006 may apply a fixed rigid-body transformation to convert an absolute position of the cGNSS antenna phase center to a reference point of the corner reflector, such as an apex vertex of the trihedral reflector. For example, the fixed rigid-body transformation may be determined based at least in part on known mechanical dimensions of the corner reflector, survey measurements associated with one or more Funderpins, a least-squares analysis of Funderpin survey measurements, or a combination thereof. In some cases, computation components 1006 may dynamically fuse position data, velocity data, orientation data, acceleration data, Funderpin-derived measurements, and/or other information described herein using one or more filtering algorithms, such as an Extended Kalman Filter, an Unscented Kalman Filter, a complementary filter, or a combination thereof. Such filtering may be used, for example, to estimate the reflector state information, correct IMU drift using cGNSS updates, incorporate Funderpin orientation measurements when available, compensate for environmental disturbances, and/or generate control information for actuation components 1004 to orient the corner reflector toward a target satellite line-of-sight geometry during one or more geodetic operations. In some instances, the fused data and/or reflector state information may support high-accuracy geodetic determinations, alignment determinations, stability determinations, and/or control operations based on one or more positioning-accuracy, positioning-resolution, repeatability, and/or orientation-accuracy ranges described herein. For example, the fused data and/or reflector state information may support sub-centimeter position accuracy and orientation accuracy within approximately 1 degree, within approximately 0.5 degrees, within approximately 0.1 degrees, within approximately 0.05 degrees, within approximately 0.01 degrees, or better. In some aspects, the fused data and/or reflector state information may support orientation accuracy of approximately 0.01 degrees or better through sensor fusion using one or more IMUs, cGNSS receivers and/or antennas 1008, and/or other sensing components 1002. In some examples, higher-precision configurations may support orientation accuracy within approximately 0.001 degrees to approximately 0.005 degrees, such as approximately 0.0025 degrees or approximately 0.001 degrees, for lunar, space-adjacent, laser reflectometry, or other high-precision applications.

By way of example, at a first instance, computation components 1006 may obtain sensor data from sensing components 1002 and, optionally, position information from the one or more cGNSS receivers and/or antennas 1008, actuation feedback from actuation components 1004, survey or Funderpin measurement information, satellite pass information, target line-of-sight information, baseline reflector state information, commanded reflector state information, and/or other information associated with a geodetic operation. In some aspects, computation components 1006 may generate fused data based at least in part on the sensor data and/or one or more of the foregoing additional information types. Based at least in part on the fused data, the sensor data, and/or one or more of the foregoing additional information types, computation components 1006 may determine reflector state information of the corner reflector at the first instance, such as, without limitation, a reflector pose, an alignment state, a stability condition, a disturbance condition, an actuation state, a geodetic position, a timestamp, and/or another operating-condition characteristic of the corner reflector.

Additionally or alternatively, the reflector state information may include and/or be used to determine a change in reflector state information. For example, continuing from the example above, at a second instance, computation components 1006 may obtain second sensor data from sensing components 1002 and, optionally, second position information from the one or more cGNSS receivers and/or antennas 1008, second actuation feedback from actuation components 1004, second survey or Funderpin measurement information, second satellite pass information, second target line-of-sight information, second baseline reflector state information, second commanded reflector state information, and/or other second information associated with the geodetic operation. In some aspects, computation components 1006 may generate second fused data based at least in part on the second sensor data and/or one or more of the foregoing additional second information types. Based at least in part on the second fused data, the second sensor data, and/or one or more of the foregoing second information types, computation components 1006 may determine second reflector state information, such as a second reflector pose, second alignment state, second stability condition, second disturbance condition, second actuation state, second geodetic position, and/or second timestamp. Moreover, computation components 1006 may compare the first reflector state information and the second reflector state information to determine a change in the reflector state information. For instance, computation components 1006 may determine a pose change, alignment change, stability change, disturbance change, actuation-state change, geodetic-position change, elapsed time, rate of change, and/or another change in an operating-condition characteristic of the corner reflector.

In some aspects, computation components 1006 may determine whether the change in the reflector state information satisfies, exceeds, or otherwise triggers one or more thresholds associated with a geodetic operation. For example, the one or more thresholds may include a pose-change threshold, angular deviation threshold, azimuth threshold, elevation threshold, tilt threshold, displacement threshold, vibration threshold, stability threshold, disturbance threshold, tamper threshold, alignment tolerance, rate-of-change threshold, elapsed-time threshold, and/or another threshold associated with determining whether the corner reflector is aligned, stable, displaced, disturbed, tampered with, or otherwise within an acceptable operating condition for the geodetic operation. In some instances, computation components 1006 may generate control information, update reflector state information, generate a disturbance or tamper record, generate contemporaneous state documentation, communicate an alert associated with the change in reflector state information, and/or otherwise update performance of a geodetic operation based on determining that the change in the reflector state information satisfies the one or more thresholds.

In some configurations, computation components 1006 may generate control information based at least in part on the fused data, the reflector state information, a change in the reflector state information, one or more thresholds associated with a geodetic operation, and/or other information described herein. The control information may include one or more commands, parameters, instructions, setpoints, target values, tolerance values, timing values, mode selections, actuator-control signals, and/or other information usable to control or coordinate operation of one or more components of the SAR corner reflector system 1000. For example, the control information may be usable to control actuation components 1004 to move the corner reflector toward a target alignment state, maintain the corner reflector within an acceptable alignment tolerance, correct a detected pose deviation, compensate for disturbance-induced movement, reduce vibration or oscillation, transition actuation components 1004 between an unlocked or movable state and a locked or holding state, return the corner reflector to a baseline or commanded reflector pose, and/or perform another operation associated with a geodetic operation.

In some configurations, computation components 1006 may generate control information associated with aligning an aperture of the corner reflector with a target satellite line-of-sight geometry during a corresponding observation window, referred to herein as ‘self-directed alignment control information.’ The self-directed alignment control information may enable self-directed alignment to be performed without manual intervention. As described herein, the self-directed alignment control information may be based at least in part on the fused data, the reflector state information, position information from the one or more cGNSS receivers and/or antennas 1008, satellite pass information associated with one or more target satellites, target line-of-sight information, and/or other information described herein. In some instances, satellite pass information may include, without limitation, orbital parameters, orbital ephemeris data, repeat-cycle timing, acquisition timing information, look-direction geometry, look-angle information, pass schedule information, satellite identity information, mission information, frequency-band information, and/or other information associated with a satellite observation window.

In some examples, computation components 1006 may obtain and/or store satellite pass information associated with one or more target satellites from one or more satellite pass information sources, such as, without limitation, publicly available sources, two-line element sets, mission-specific ephemerides provided by a satellite operator, third-party orbital-data services, user-provided satellite schedule files, operator-provided mission planning systems, or a combination thereof. Additionally, or alternatively, satellite pass information associated with the one or more target satellites may be pre-loaded into the one or more computation components 1006 before deployment based on information from the one or more satellite pass information sources. In some cases, the satellite pass information may be updated periodically based on updated information received from the one or more satellite pass information sources via a remote communication link, cellular communication link, satellite communication link, direct data link, or other communication link. In some aspects, the satellite pass information may be updated based on information received from the one or more satellite pass information sources during routine maintenance, field service, or another update operation. In some instances, the one or more computation components 1006 may be satellite-agnostic, such that the self-directed alignment capability does not rely on receiving live telemetry from the target satellite and may be applied to any satellite for which orbital parameters or other pass information are available.

As described herein, computation components 1006 may determine or calculate a target alignment state for orienting the aperture of the corner reflector toward the line-of-sight geometry of a target satellite at the time of a scheduled overpass. In some examples, computation components 1006 may determine the position and line-of-sight geometry of the target satellite at the time of the scheduled overpass. Such determination may be based on precise timing information derived from the one or more cGNSS receivers and/or antennas 1008, one or more of orbital ephemeris data, satellite look direction, scheduled overpass geometry, and/or other satellite pass information described herein. Additionally, computation components 1006 may determine the current geodetic state of the corner reflector at the time of the calculation. Such determination may be based at least in part on the fused data, the reflector state information, and/or other information described herein, and may indicate, for example, one or more of a geodetic position, a reflector pose, a boresight direction, an aperture orientation, and/or another spatial or angular characteristic of the corner reflector relative to a defined reference frame. Based on such determinations, computation components 1006 may determine or compute the target alignment state, including, without limitation, the azimuth, elevation, and/or other pointing parameters for orienting the aperture of the corner reflector toward the line-of-sight geometry of the target satellite at the time of the scheduled overpass.

In some cases, computation components 1006 may determine an alignment error based at least in part on a comparison between the current reflector state and the determined target alignment state. The alignment error may indicate one or more of an azimuth error, elevation error, tilt error, pitch error, roll error, yaw error, boresight-direction error, aperture-orientation error, and/or another deviation between the current reflector state and the target alignment state. Based at least in part on the alignment error, computation components 1006 may generate self-directed alignment control information including one or more commands or other control information of the types described herein, usable to cause actuation components 1004 to move the corner reflector from the current reflector state toward the target alignment state.

Moreover, computation components 1006 may provide or transmit the self-directed alignment control information to actuation components 1004. Based on the self-directed alignment control information, actuation components 1004 may slew or otherwise move the corner reflector toward the target alignment state. In some instances, while actuation components 1004 slews or otherwise moves the corner reflector toward the target alignment state (hereinafter the “slew phase”), computation components 1006 may monitor updated sensor data, updated cGNSS information, and/or updated actuation feedback to track progress of the corner reflector toward the target alignment state.

In some aspects, the slew rate of actuation components 1004 during the slew phase may be configurable or selectable based on one or more of the available time window, the required reorientation angle, the expected settling and confirmation time, and/or another operational parameter associated with the geodetic operation. In some instances, the slew rate may be selected to be sufficient to complete the reorientation within the available time window while allowing time for closed-loop fine adjustment and alignment confirmation prior to commencement of the observation window. By way of example, such slew rate may be approximately 5 degrees per second, approximately 10 degrees per second, approximately 20 degrees per second or more, or another rate suitable for the geodetic operation. In some configurations, the computation components 1006 may configure or select the slew rate based on any combination of the techniques described above and may generate self-directed alignment control information that includes the configured or selected slew rate.

In some configurations, computation components 1006 may generate self-directed alignment control information for multiple satellite passes, satellite missions, frequency bands, and/or observation windows. For example, computation components 1006 may store orbital parameters or other satellite pass information for a plurality of SAR satellites operating across multiple frequency bands. For each scheduled satellite pass of a selected satellite from the plurality, computation components 1006 may determine the position and line-of-sight geometry of the selected satellite at the time of the scheduled overpass based at least in part on precise timing information derived from the one or more cGNSS receivers and/or antennas 1008, in combination with one or more of orbital ephemeris data, satellite look direction, scheduled overpass geometry, and/or other satellite pass information associated with the selected satellite. Additionally, computation components 1006 may determine the current geodetic state of the corner reflector at the time of the calculation based at least in part on the fused data, the reflector state information, and/or other information described herein. Based on such determinations, computation components 1006 may compute a target alignment state for the selected satellite pass, which may include the azimuth, elevation, and/or other pointing parameters for orienting the aperture of the corner reflector toward the line-of-sight geometry of the selected satellite at the time of the scheduled overpass, and may generate self-directed alignment control information commanding actuation components 1004 to move the corner reflector toward the computed target alignment state. In some instances, computation components 1006 may repeat such determination and computation for each scheduled satellite pass of each satellite in the plurality, thereby enabling a single SAR corner reflector system 1000 to automatically align with each scheduled satellite pass without manual reorientation between passes.

In some examples, the plurality of SAR satellites may include NISAR, the Sentinel-1 constellation, TerraSAR-X, TanDEM-X, government SAR satellites, commercial SAR satellites, future SAR satellites, successor SAR satellites, and/or other SAR satellites operating in L-band, S-band, C-band, X-band, Ku-band, P-band, or another frequency band. Such multi-satellite and/or multi-band alignment may enable a single SAR corner reflector system 1000 to support calibration and/or validation operations across different orbital geometries and frequency bands from a single field installation.

In some cases, where two or more satellite passes are consecutive, overlapping, or otherwise in conflict, computation components 1006 may apply a priority-based scheduling algorithm to determine which satellite pass to service. In some aspects, the priority-based scheduling algorithm may assign one or more user-defined priority levels to each scheduled satellite pass, which may be defined or updated by an operator. In some instances, such priority levels may be based on one or more of mission designation, operating frequency band, time elapsed since the last completed calibration or validation event for a given mission, operator-defined mission priority ranking, or a combination thereof.

In some examples, computation components 1006 may use the slew rate of actuation components 1004 to determine whether rapid reorientation between conflicting satellite passes is feasible within the available time window. Where reorientation is determined to be feasible, computation components 1006 may generate self-directed alignment control information commanding actuation components 1004 to slew the corner reflector toward the target alignment state of the higher-priority satellite pass within the available time window. Alternatively, where reorientation is determined not to be feasible within the available time window, computation components 1006 may select the higher-priority satellite pass for service. Additionally, or alternatively, where reorientation is determined not to be feasible within the available time window, computation components 1006 may log the unserviced satellite pass, flag it for operator notification, schedule the SAR corner reflector system 1000 to service a later available observation window for the unserviced satellite or mission, or a combination thereof.

In some aspects, after actuation components 1004 move the corner reflector toward the target alignment state, computation components 1006 may receive updated sensor data, updated cGNSS information, updated actuation feedback, and/or other updated information described herein to determine whether the corner reflector is within an acceptable alignment tolerance before the observation window. If the updated reflector state information indicates that the corner reflector is outside the acceptable alignment tolerance, computation components 1006 may generate additional self-directed alignment control information to further adjust the corner reflector. In some examples, the acceptable alignment tolerance may be within approximately 1 degree, within approximately 0.5 degrees, within approximately 0.1 degrees, within approximately 0.05 degrees, within approximately 0.01 degrees, within approximately 0.005 degrees, within approximately 0.0025 degrees, within approximately 0.001 degrees, or another tolerance suitable for a corresponding geodetic operation.

In some configurations, following the slew phase and/or another alignment operation described herein, computation components 1006 may perform closed-loop fine adjustments to actuation components 1004 until the fused data confirms that the corner reflector is aligned with the target satellite line-of-sight geometry. For example, sensing components 1002, such as an IMU and/or accelerometer, may provide real-time feedback usable by computation components 1006 to perform such closed-loop fine adjustments.

In some examples, computation components 1006 may determine whether the corner reflector is aligned with the target satellite line-of-sight geometry based on a predetermined or acceptable alignment tolerance. By way of example, an acceptable alignment tolerance may be within a range of approximately 0.001 degrees to approximately 0.1 degrees, or another tolerance suitable for a corresponding geodetic operation. For example, following the slew phase and/or another alignment operation described herein, sensing components 1002 may provide sensor data to computation components 1006 indicating one or more of an orientation, tilt, angular displacement, angular velocity, vibration, acceleration, boresight direction, aperture orientation, reflector pose, movement condition, and/or another reflector state characteristic of the corner reflector. Based on the sensor data, the fused data, the reflector state information, and the acceptable alignment tolerance, computation components 1006 may determine whether the corner reflector is aligned with the target satellite line-of-sight geometry within the acceptable alignment tolerance. Based on determining that the corner reflector is aligned with the target satellite line-of-sight geometry within the acceptable alignment tolerance, computation components 1006 may confirm an aligned state, maintain the commanded pointing geometry, transition actuation components 1004 from an unlocked or movable state to a locked or holding state, initiate contemporaneous state documentation, and/or perform another operation associated with the geodetic operation. Alternatively, based on determining that the corner reflector is not aligned with the target satellite line-of-sight geometry within the acceptable alignment tolerance, computation components 1006 may generate or update stability-maintenance control information to cause actuation components 1004 to perform one or more additional fine adjustments toward the target satellite line-of-sight geometry.

In some instances, the corner reflector may remain in the commanded orientation, that is, the target alignment state computed for the corresponding satellite pass, for a duration of an observation window. As described herein, the observation window may be predetermined based at least in part on orbital parameters and ephemeris data associated with the target satellite, such as a duration of approximately 8 minutes to approximately 15 minutes per satellite pass, or another duration associated with the corresponding satellite pass. In some aspects, computation components 1006 may update timing associated with the observation window, select a portion of the observation window, and/or update an operational window for a corresponding geodetic operation based on one or more of the completion of the slew phase, confirmation of the aligned state within the acceptable alignment tolerance, detection of a disturbance or integrity-related event, a scheduling conflict with a consecutive or overlapping satellite pass, and/or another operational condition of SAR corner reflector system 1000. During the observation window, computation components 1006 may perform real-time closed-loop stability maintenance of the commanded pointing geometry, as described in further detail herein.

In some configurations, computation components 1006 may generate control information associated with maintaining the commanded pointing geometry of the corner reflector during a corresponding observation window (hereinafter “stability-maintenance control information”). The stability-maintenance control information may be used to perform real-time closed-loop stability maintenance of the commanded pointing geometry against environmental disturbances, movement events, vibration events, and/or other changes in reflector state, including but not limited to wind loading, ground vibration, thermal expansion of structural components, ground movement, settlement-related movement, mechanical backlash, actuator slippage, impact, unauthorized movement, tampering, structural deformation, structural compromise, and/or another disturbance or integrity-related event described herein. Such closed-loop stability maintenance may be based at least in part on the fused data, the reflector state information, a change in the reflector state information, updated sensor data from sensing components 1002, updated position information from cGNSS receivers and/or antennas 1008, updated actuation feedback from actuation components 1004, and/or other information described herein. In some configurations, the closed-loop stability maintenance may operate continuously during the observation window without manual intervention.

In some examples, during the observation window, computation components 1006 may sample sensor data from sensing components 1002 to determine a current reflector state of the corner reflector relative to the commanded pointing geometry, also referred to herein as the target alignment state. For example, computation components 1006 may obtain or receive sensor data from sensing components 1002, such as by continuously sampling high-rate sensor data from an IMU and/or accelerometer, including, without limitation, one or more of tilt, angular rate, vibration, acceleration, motion, and/or other orientation or movement measurements of the corner reflector. As described herein, such sensor data may be fused and/or combined with position information from cGNSS receivers and/or antennas 1008, actuation feedback from actuation components 1004, and/or other information described herein in real time. Based on the sensor data, fused data and/or other information described herein, computation components 1006 may determine the current reflector state of the corner reflector, such as, without limitation, a current orientation state, current stability condition, and/or another reflector state characteristic. Based on the current reflector state and the target alignment state, computation components 1006 may compare the current reflector state and the target alignment state to determine or quantify a stability-maintenance error. The stability-maintenance error may represent a deviation between the current reflector state and the commanded pointing geometry. Examples of stability-maintenance error may include, without limitation, an azimuth error, elevation error, tilt error, pitch error, roll error, yaw error, boresight-direction error, aperture-orientation error, positional error, and/or another deviation between the current reflector state and the commanded pointing geometry. In some instances, the stability-maintenance error may be expressed as a magnitude, direction, rate of change, and/or another characteristic of the deviation usable by computation components 1006 to determine whether a corrective adjustment is warranted, as described in further detail herein.

In some cases, computation components 1006 may determine whether to generate stability-maintenance control information for actuation components 1004 based on the stability-maintenance error. In some aspects, computation components 1006 may generate the stability-maintenance control information when the stability-maintenance error satisfies, exceeds, or otherwise triggers one or more programmable thresholds. For example, the one or more programmable thresholds may include an angular threshold, positional threshold, vibration threshold, tilt threshold, stability threshold, alignment tolerance, or a combination thereof. By way of example, the one or more programmable thresholds may include an angular threshold of approximately 0.01 degrees, or another value selected based on requirements of a corresponding geodetic operation. In some instances, the one or more programmable thresholds may be configured to conserve power, reduce actuator wear, reduce unnecessary actuation, and/or improve stability of the corner reflector, such that corrective adjustments are issued only when the stability-maintenance error exceeds a threshold and no motor activity is commanded when the corner reflector is already within the target tolerance.

Based on determining that the stability-maintenance error satisfies, exceeds, or otherwise triggers the one or more programmable thresholds, computation components 1006 may generate stability-maintenance control information commanding actuation components 1004 to apply one or more incremental corrective adjustments to return the corner reflector toward the commanded pointing geometry or maintain the corner reflector within the acceptable alignment tolerance. For example, computation components 1006 may use the stability-maintenance error, including its magnitude, direction, and/or rate of change as described above, to determine the type, magnitude, direction, and/or timing of one or more corrective adjustments required to reduce the stability-maintenance error and return the current reflector state toward the commanded pointing geometry. In some instances, such corrective adjustments may include one or more of a corrective azimuth adjustment, corrective elevation adjustment, corrective tilt adjustment, corrective pitch adjustment, corrective roll adjustment, corrective yaw adjustment, corrective height adjustment, locking adjustment, braking adjustment, holding adjustment, and/or another adjustment associated with the geodetic operation.

Based on the determined corrective adjustments, computation components 1006 may generate stability-maintenance control information including one or more commands, setpoints, target values, timing values, actuator-control signals, and/or other control information of the types described herein, corresponding to the determined corrective adjustments. The stability-maintenance control information may then be provided to actuation components 1004 for implementation. In some aspects, upon receiving the stability-maintenance control information, actuation components 1004 may apply the incremental corrective adjustments to reposition the corner reflector toward the commanded pointing geometry, as described herein.

In some aspects, the correction loop may repeat at a sampling rate of sensing components 1002, such as a sampling rate between approximately 100 Hz and approximately 800 Hz, or another rate suitable for the corresponding geodetic operation, until the observation window ends, the stability-maintenance error falls within the target tolerance, and/or another termination condition is satisfied.

In some cases, computation components 1006 may use disturbance events, integrity-related events, and/or changes in reflector state information when generating or updating the stability-maintenance control information. For instance, if computation components 1006 determine that movement, vibration, impact, tilt, displacement, structural deformation, unauthorized movement, tampering, actuator slippage, or another event has affected or may affect the alignment state of the corner reflector, computation components 1006 may update the stability-maintenance control information, generate corrective control information, delay confirmation of a stable state, generate an alert associated with the disturbance event or integrity-related event, generate a disturbance or tamper record, and/or prevent generation of contemporaneous state documentation or a digital certificate indicating an acceptable aligned or stable condition until the reflector state information satisfies, exceeds, or otherwise triggers one or more stability-maintenance thresholds. In some aspects, stability-maintenance information logged during the observation window may be used as part of the verifiable state documentation generated at the conclusion of the observation window, as described in further detail herein.

In some configurations, the observation window may correspond to an extended dwell operating mode in which the target satellite, radar beam, sensor, or other radar platform continues to illuminate, observe, or otherwise collect radar return information from the same target ground area, ground spot, scene, or region of interest during a dwell period. In such configurations, the corner reflector may be controlled so that an aperture, boresight direction, or other pointing axis of the corner reflector remains directed toward the target satellite, radar beam source, or corresponding line-of-sight geometry as that line-of-sight geometry changes during the dwell period. For example, computation components 1006 may determine a time-varying target alignment trajectory for the dwell period. The time-varying target alignment trajectory may include a sequence, curve, table, function, schedule, or other representation of target azimuth values, target elevation values, target tilt values, target boresight directions, target aperture orientations, and/or other target pointing parameters for keeping the aperture, boresight direction, or other pointing axis of the corner reflector directed toward the target satellite, radar beam source, or corresponding line-of-sight geometry at different times or epochs during the dwell period.

In some examples, computation components 1006 may determine the time-varying target alignment trajectory based at least in part on satellite pass information, orbital ephemeris data, acquisition timing information, target ground-area information, look-direction geometry, precise timing information from cGNSS receivers and/or antennas 1008, current or predicted geodetic position information of the corner reflector, fused data, reflector state information, and/or other information described herein. For example, computation components 1006 may determine a plurality of predicted line-of-sight geometries between the corner reflector and the target satellite at a plurality of respective epochs during the dwell period. Based on the plurality of predicted line-of-sight geometries, computation components 1006 may generate the time-varying target alignment trajectory for orienting the aperture of the corner reflector toward the target satellite as the target satellite moves along its orbital path during the dwell period.

In some aspects, computation components 1006 may use the time-varying target alignment trajectory to generate extended dwell control information for controlling the corner reflector during the dwell period. The extended dwell control information may include one or more commands, setpoints, timing values, tracking-rate values, actuator-control signals, and/or other control information usable by actuation components 1004 to continuously or periodically adjust the corner reflector so that an aperture, boresight direction, or other pointing axis of the corner reflector remains directed toward the target satellite, radar beam source, or corresponding line-of-sight geometry as the line-of-sight geometry changes during the dwell period. For example, the extended dwell control information may cause actuation components 1004 to adjust one or more of azimuth, elevation, tilt, pitch, roll, yaw, boresight direction, aperture orientation, and/or another positional or angular characteristic of the corner reflector based on corresponding target pointing parameters of the time-varying target alignment trajectory. In this way, actuation components 1004 may dynamically move the corner reflector during the extended dwell operating mode to follow the changing line-of-sight geometry of the target satellite rather than merely holding the corner reflector at a fixed pointing geometry.

In some cases, computation components 1006 may perform closed-loop tracking during the extended dwell operating mode. For example, during the dwell period, computation components 1006 may receive updated sensor data from sensing components 1002, updated position information from cGNSS receivers and/or antennas 1008, updated actuation feedback from actuation components 1004, and/or updated fused data. Computation components 1006 may compare the updated reflector state information to a corresponding target pointing parameter of the time-varying target alignment trajectory for a current epoch of the dwell period to determine an extended dwell tracking error. The corresponding target pointing parameter may represent a target azimuth, target elevation, target boresight direction, target aperture orientation, and/or another target reflector state characteristic for keeping an aperture, boresight direction, or other pointing axis of the corner reflector directed toward the target satellite, radar beam source, or corresponding line-of-sight geometry at the current epoch. The extended dwell tracking error may indicate one or more of an azimuth error, elevation error, tilt error, pitch error, roll error, yaw error, boresight-direction error, aperture-orientation error, positional error, timing error, tracking-rate error, and/or another deviation between the current reflector state and the corresponding target pointing parameter for the current epoch.

Based at least in part on the extended dwell tracking error, computation components 1006 may determine whether to generate updated extended dwell control information. For instance, computation components 1006 may determine whether the extended dwell tracking error satisfies, exceeds, or otherwise triggers one or more extended dwell tracking thresholds, including an angular threshold, positional threshold, timing threshold, tracking-rate threshold, stability threshold, alignment tolerance, or a combination thereof. Based on determining that the extended dwell tracking error satisfies, exceeds, or otherwise triggers one or more extended dwell tracking thresholds, computation components 1006 may generate updated extended dwell control information commanding actuation components 1004 to apply one or more corrective tracking adjustments. Such corrective tracking adjustments may be configured to reduce the extended dwell tracking error and adjust the corner reflector toward the corresponding target pointing parameter of the time-varying target alignment trajectory for the current or subsequent epoch of the dwell period.

In some instances, the extended dwell control information may be generated at a control-update rate selected based on one or more of a duration of the dwell period, a rate of change of the line-of-sight geometry, a required pointing accuracy, actuator capabilities, power constraints, sensor sampling rate, cGNSS timing rate, and/or another operational parameter associated with the extended dwell operating mode. For example, computation components 1006 may generate or update the extended dwell control information continuously, periodically, once per second, multiple times per second, at a rate up to approximately 100 Hz, or at another rate suitable for the corresponding extended dwell operating mode. In some examples, the control-update rate may be lower than a sensor sampling rate of sensing components 1002, such that high-rate sensor data is used to determine reflector state information and tracking error while actuator commands are issued at a rate suitable for actuation components 1004 and the corresponding geodetic operation.

In some aspects, the extended dwell operating mode may be coordinated with the self-directed alignment and closed-loop stability maintenance operations described herein. For example, before commencement of the dwell period, computation components 1006 may perform self-directed alignment to move the corner reflector toward an initial target pointing parameter of the time-varying target alignment trajectory. During the dwell period, computation components 1006 may perform closed-loop tracking based on the time-varying target alignment trajectory and updated reflector state information to keep an aperture, boresight direction, or other pointing axis of the corner reflector directed toward the target satellite, radar beam source, or corresponding line-of-sight geometry as the line-of-sight geometry changes. Additionally, computation components 1006 may perform closed-loop stability maintenance during the extended dwell operating mode to compensate for wind loading, vibration, thermal expansion, actuator slippage, ground movement, tampering, and/or other disturbances that may affect the ability of the corner reflector to follow the time-varying target alignment trajectory. At or after completion of the dwell period, computation components 1006 may generate verifiable state documentation associated with one or more epochs of the extended dwell operating mode, as described herein.

In some configurations, computation components 1006 may generate verifiable state documentation associated with a geodetic position, orientation, alignment state, stability condition, and/or other reflector state information of the corner reflector at a calibration epoch, validation epoch, observation window, satellite pass, and/or other geodetic operation. In some aspects, the verifiable state documentation may be generated upon the occurrence of one or more geodetic operation events, including, without limitation, completion of a commanded alignment with a target satellite pass, confirmation that the corner reflector is within an acceptable alignment tolerance, commencement of an observation window, conclusion of an observation window, detection of a change in reflector state, and/or another event associated with a geodetic operation. As described herein, the verifiable state documentation may be based at least in part on the fused data, the reflector state information, stability-maintenance information, timestamp information, satellite pass information, and/or other information described herein.

In some examples, upon the occurrence of one or more geodetic operation events, computation components 1006 may collect or obtain a synchronized dataset for use in generating the verifiable state documentation. As used herein, the synchronized dataset may encompass the fused data described above, and may further comprise a point-in-time snapshot of raw and processed inputs collected together at or around the moment of the geodetic operation event, including inputs that may not yet have been incorporated into the fused data at the time of collection. For example, the synchronized dataset may include one or more of: position information from cGNSS receivers and/or antennas 1008, such as real-time kinematic corrected position information where available; sensor data from sensing components 1002, including IMU-derived orientation information, tilt information, and stability metrics; actuation feedback from actuation components 1004; a UTC timestamp corresponding to the moment of the geodetic operation event; stability-maintenance information logged during the observation window, including corrective adjustments applied, orientation errors, pose deviations, disturbance events, integrity-related events, and final stable orientation state; satellite pass information associated with the corresponding satellite pass; system health information and quality-control information, which may include processor temperature, voltage, radio-frequency interference levels, GNSS quality indicators, actuator status, communication status, power status, and/or another system condition associated with SAR corner reflector system 1000; and/or other information associated with the corresponding geodetic operation.

By way of example, a synchronized dataset collected upon completion of a commanded alignment with a target satellite pass may include, without limitation, position information from cGNSS receivers and/or antennas 1008 reflecting the geodetic position of the corner reflector at the moment of alignment confirmation, sensor data from sensing components 1002 reflecting the orientation, tilt, and stability condition of the corner reflector at the moment of alignment confirmation, actuation feedback from actuation components 1004 reflecting the achieved azimuth and elevation of the corner reflector at the moment of alignment confirmation, stability-maintenance information logged during the preceding observation window, and a UTC timestamp corresponding to the moment of alignment confirmation.

In some cases, computation components 1006 may compute a final fused geodetic state of the corner reflector based at least in part on the synchronized dataset collected at the corresponding geodetic operation event. As used herein, the final fused geodetic state refers to the point-in-time position and orientation of the corner reflector at the moment of a geodetic operation event, derived from the synchronized dataset using one or more of the rigid-body transformation, filtering algorithm, Funderpin-derived orientation measurements, cGNSS position information, sensor data from sensing components 1002, actuation feedback from actuation components 1004, and/or other processing described herein. The final fused geodetic state may include, for example, a position of a reference point of the corner reflector, such as an apex vertex reference point of the trihedral reflector, an orientation of the corner reflector, a reflector pose, an alignment state, a stability condition, a final stable orientation state, and/or another reflector state characteristic of the corner reflector at the moment of the geodetic operation event.

In some aspects, computation components 1006 may generate a timestamped digital certificate for a geodetic operation event based on the synchronized dataset, the final fused geodetic state, stability-maintenance information, and/or other reflector state information described herein associated with that geodetic operation event. The timestamped digital certificate may document one or more of: verified geodetic coordinates of the corner reflector at the moment of the geodetic operation event, expressed in one or more coordinate systems as described herein; a position of the reference point of the corner reflector, such as an apex vertex reference point of the trihedral reflector; commanded azimuth and achieved azimuth; commanded elevation and achieved elevation; commanded pointing geometry and achieved pointing geometry; stability metrics derived from the synchronized dataset, including residual vibration amplitude, pointing deviation, and corrective adjustments applied during the observation window; an identity of the target satellite, its operating frequency band, and its orbit direction; a precise UTC timestamp corresponding to the moment of the geodetic operation event; GNSS receiver and antenna identification data; system health information and quality-control information; one or more error estimates associated with the geodetic position and orientation of the corner reflector, such as one-sigma positional uncertainty and one-sigma orientational uncertainty; and/or other information associated with the geodetic operation.

In some instances, the timestamped digital certificate may be generated in a structured format compatible with one or more SAR calibration metadata conventions, SAR processing pipelines, calibration tools, validation tools, and/or downstream SAR calibration, validation, or processing systems. For example, the structured format may be based at least in part on Committee on Earth Observation Satellites (CEOS) calibration metadata conventions, mission-specific metadata requirements, client-specific metadata requirements, and/or another metadata convention, and may be tailored to the requirements of a specific SAR processing pipeline or client system. In some examples, the structured format may comprise a machine-readable format, such as JSON, XML, or another structured data format suitable for the corresponding geodetic operation.

In some examples, computation components 1006 may cryptographically sign the timestamped digital certificate to provide authenticity verification and integrity verification of the documented reflector state information. For example, cryptographic signing may employ an asymmetric cryptographic algorithm, including ECDSA, RSA, or another cryptographic algorithm, using a private key stored securely within computation components 1006 or another secure component of SAR corner reflector system 1000. In some aspects, computation components 1006 may include or communicate with a hardware security module configured to store the private key, perform a signing operation, protect certificate-generation operations, and/or provide enhanced security for the timestamped digital certificate.

In some cases, the signed timestamped digital certificate may be stored locally within computation components 1006, stored in another data-storage component of SAR corner reflector system 1000, transmitted via communication interface 1010 to a client system or downstream SAR calibration, validation, or processing system, or a combination thereof. In some aspects, local storage may support autonomous operation of SAR corner reflector system 1000 in field deployments where continuous network connectivity is not available, consistent with the onboard processing architecture described herein. In some aspects, transmission via communication interface 1010 may support immediate use of the timestamped digital certificate by a client system or downstream SAR calibration, validation, or processing system, consistent with the hybrid processing architecture described herein. For example, communication interface 1010 may support transmission via a cellular communication link, satellite communication link, direct data link, wired data link, wireless data link, and/or another communication link suitable for transmitting the timestamped digital certificate, verifiable state documentation, reflector state information, and/or other information described herein.

In some aspects, the timestamped digital certificate may be provided to one or more downstream SAR calibration, validation, or processing systems as auxiliary calibration metadata. In some aspects, the timestamped digital certificate may supplement existing SAR processing workflows by providing a verified and high-accuracy ground-truth reference of the geodetic position, orientation, alignment state, stability condition, and/or other reflector state information of the corner reflector at the moment of the corresponding geodetic operation event. Such ground-truth reference may improve the reliability of existing SAR processing operations by enabling downstream systems to correct imagery artifacts, validate instrument parameters, flag anomalies, and/or verify that radar returns from the corner reflector were acquired while the reflector was aligned, stable, and within an acceptable operating condition. In some aspects, the downstream system may incorporate the timestamped digital certificate into one or more existing processing operations associated with SAR imagery acquired during the corresponding satellite pass, such as geometric correction, radiometric correction, absolute calibration, validation, and/or another processing operation, automatically, subject to human analyst review, or a combination thereof. In some aspects, the timestamped digital certificate may further be applicable to SAR imagery acquired by satellites other than the primary target satellite for a given observation window, as described in further detail herein.

In some aspects, the timestamped digital certificate generated for a first satellite pass may be applicable to SAR imagery acquired by one or more additional satellites observing the same area during the same or a proximate observation period. For example, where a first timestamped digital certificate is generated for a first satellite pass, as described herein, computation components 1006 may use the first timestamped digital certificate together with satellite pass information associated with one or more additional satellites to determine whether the orientation of the corner reflector at the moment of the geodetic operation event associated with the first timestamped digital certificate is within an acceptable operating condition for SAR imagery acquired by the one or more additional satellites. Such determination may be based at least in part on the documented azimuth, elevation, and pointing geometry of the corner reflector recorded in the first timestamped digital certificate, together with the look direction, orbital geometry, and frequency band of the one or more additional satellites. Moreover, where computation components 1006 determine that the orientation of the corner reflector documented in the first timestamped digital certificate is within an acceptable operating condition for the one or more additional satellites, the first timestamped digital certificate may be provided to downstream SAR calibration, validation, or processing systems associated with the one or more additional satellites as auxiliary calibration metadata, as described herein.

In some aspects, a time-series of timestamped digital certificates generated across multiple geodetic operation events, observation windows, satellite passes, missions, and/or observation epochs may support epoch-by-epoch geodetic comparisons of the corner reflector's absolute position and orientation over extended time periods. For example, because each geodetic operation event may be associated with a timestamped digital certificate documenting the corner reflector's geodetic state at that event, computation components 1006 may use a time-series of such timestamped digital certificates to support determination of long-term changes in the absolute position and orientation of the corner reflector. In some aspects, such long-term changes may include, without limitation, tectonic plate motion, regional subsidence, surface deformation, post-seismic displacement, and/or another long-term geodetic change occurring over extended time periods. In some aspects, because each timestamped digital certificate in the time-series provides a high-accuracy, verified record of the corner reflector's geodetic state at the moment of a corresponding geodetic operation event, the time-series may enable continuous, automated, long-term geodetic monitoring from a single field installation. In some aspects, such epoch-by-epoch geodetic comparisons may be performed by computation components 1006, by a downstream SAR calibration, validation, or processing system, by a separate analysis tool, or by a combination thereof.

In some configurations, the verifiable state documentation and/or timestamped digital certificate may be associated with an extended dwell operating mode. For example, the verifiable state documentation and/or timestamped digital certificate may include time-indexed reflector state information for a plurality of epochs during the dwell period. As described herein, the reflector state information for the plurality of epochs during the dwell period may include one or more time-indexed reflector state records during the dwell period. Each time-indexed reflector state record may correspond to a respective epoch of the dwell period and may document a reflector state of the corner reflector at that respective epoch. In some instances, each time-indexed reflector state record may indicate one or more of a geodetic position, reflector pose, achieved azimuth, achieved elevation, achieved boresight direction, achieved aperture orientation, target pointing parameter of the time-varying target alignment trajectory, extended dwell tracking error, stability condition, disturbance condition, actuation state, actuation command, corrective tracking adjustment, timestamp, and/or another operating-condition characteristic of the corner reflector at the respective epoch.

In some examples, the plurality of time-indexed reflector state records may be generated based at least in part on synchronized datasets collected at different times during the dwell period. For example, for each epoch of the dwell period, computation components 1006 may collect or obtain a corresponding synchronized dataset comprising position information from cGNSS receivers and/or antennas 1008, sensor data from sensing components 1002, actuation feedback from actuation components 1004, fused data, satellite pass information, a target pointing parameter of the time-varying target alignment trajectory, extended dwell control information, extended dwell tracking error information, stability-maintenance information, system health information, quality-control information, and/or a UTC timestamp associated with the corresponding epoch. Computation components 1006 may use each corresponding synchronized dataset to determine a corresponding fused geodetic state of the corner reflector for the respective epoch.

In some aspects, computation components 1006 may generate one or more timestamped digital certificates associated with the extended dwell operating mode based at least in part on the plurality of time-indexed reflector state records. For example, computation components 1006 may generate a single timestamped digital certificate comprising multiple time-indexed reflector state records for the dwell period. Additionally, or alternatively, computation components 1006 may generate multiple timestamped digital certificates during the dwell period, with each timestamped digital certificate corresponding to a respective epoch, group of epochs, control-update interval, acquisition segment, or other portion of the dwell period. In some aspects, the one or more timestamped digital certificates may document how the corner reflector was controlled to keep an aperture, boresight direction, or other pointing axis directed toward the target satellite, radar beam source, or corresponding line-of-sight geometry as the line-of-sight geometry changed during the dwell period.

In some cases, computation components 1006 may generate the time-indexed reflector state records, timestamped digital certificates, or other verifiable state documentation at a documentation rate selected based on one or more of a duration of the dwell period, a control-update rate, a sensor sampling rate, a cGNSS timing rate, a rate of change of the line-of-sight geometry, requirements of a downstream SAR calibration, validation, or processing system, a data-storage constraint, a communication constraint, a power constraint, and/or another operational parameter associated with the extended dwell operating mode. For example, the documentation rate may be once per dwell period, once per acquisition segment, once per second, multiple times per second, up to approximately 100 Hz, or another rate suitable for the corresponding extended dwell operating mode. In some instances, the documentation rate may be different from the control-update rate and/or the sensor sampling rate.

In some instances, the verifiable state documentation associated with the extended dwell operating mode may be provided to one or more downstream SAR calibration, validation, or processing systems as auxiliary calibration metadata for an extended dwell SAR acquisition. For example, the downstream system may use the plurality of time-indexed reflector state records to correlate reflector state information with corresponding times, pulses, looks, sub-apertures, image frames, acquisition segments, or other portions of the extended dwell SAR acquisition. In this way, the downstream system may determine whether different portions of the extended dwell SAR acquisition were obtained while the corner reflector was aligned with the corresponding target pointing parameters, stable, and within an acceptable operating condition. In some instances, the downstream system may use the verifiable state documentation to support geometric calibration, radiometric calibration, image-quality validation, interferometric processing, video-like SAR product generation, anomaly detection, or another SAR calibration, validation, or processing operation associated with the extended dwell SAR acquisition.

In some configurations, computation components 1006 may use sensor data from sensing components 1002, reflector state information, and/or changes in reflector state information to perform tamper detection and structural integrity monitoring of the corner reflector. As described herein, sensing components 1002 may continuously generate sensor data associated with the physical state of the corner reflector, including orientation, tilt, angular displacement, angular velocity, vibration, acceleration, and/or other motion or movement characteristics. Computation components 1006 may monitor such sensor data against one or more tamper detection thresholds to determine whether a tamper event, integrity-related event, or unauthorized change in reflector state has occurred. For example, if computation components 1006 determine that a change in reflector state, such as unexpected displacement, unauthorized movement, impact, structural deformation, or structural compromise, satisfies, exceeds, or otherwise triggers one or more tamper detection thresholds, computation components 1006 may determine that a tamper event or integrity-related event has occurred.

Based on determining that a tamper event or integrity-related event has occurred, computation components 1006 may perform one or more of the following: generate an alert associated with the tamper event or integrity-related event and communicate the alert via a remote communication link, such as a cellular, satellite, or direct communication link; generate a tamper detection record documenting the nature, magnitude, direction, and UTC timestamp of the detected event; update the reflector state information to reflect the detected tamper event or integrity-related event; delay confirmation of an aligned or stable state until the reflector state information indicates that the corner reflector satisfies, exceeds, or otherwise triggers one or more alignment or stability-maintenance criteria; and/or prevent generation of contemporaneous state documentation or a digital certificate indicating an acceptable aligned or stable condition until the reflector state information indicates that the tamper event or integrity-related event has been resolved, cleared, or otherwise accounted for. In some aspects, the tamper detection record may be incorporated into or associated with the verifiable state documentation or digital certificate generated for the next scheduled observation window, thereby providing a chain-of-custody or audit record for the geodetic state of the corner reflector, as described herein.

In some examples, the one or more tamper detection thresholds may be distinct from the one or more programmable thresholds used for stability-maintenance control information generation, as described herein. For example, the tamper detection thresholds may be configured to distinguish between routine environmental disturbances, such as wind loading, vibration, and thermal expansion, that are addressed by the closed-loop stability maintenance described herein, and non-routine events, such as unauthorized movement, impact, or structural compromise, that may indicate a tamper event or integrity-related event requiring operator notification and documentation. In some aspects, the tamper detection thresholds may be configurable or selectable by an operator based on the deployment environment, security requirements, and/or operational context of the SAR corner reflector system 1000.

In some cases, tamper detection may operate continuously and independently of the scheduled geodetic operations described herein, including during periods between observation windows when the corner reflector is not actively aligned with a target satellite. In some aspects, the tamper detection capability may be particularly relevant for SAR corner reflector systems 1000 deployed in unattended, remote, or security-sensitive locations where unauthorized movement or physical interference with the corner reflector could introduce systematic errors into the calibration and validation record, compromise the integrity of the verifiable state documentation, and/or affect the reliability of epoch-by-epoch geodetic comparisons performed using the digital certificates described herein.

In some configurations, cGNSS receivers and/or antennas 1008 may be configured to generate, receive, determine, and/or provide position information, timing information, and/or other geodetic information associated with SAR corner reflector system 1000. For example, cGNSS receivers and/or antennas 1008 may provide precise time information, absolute position information, real-time kinematic corrected position information where available, cGNSS antenna phase-center information, and/or other information usable by computation components 1006 to determine reflector state information, generate fused data, determine a target alignment state, generate control information, generate verifiable state documentation, and/or perform another geodetic operation described herein. In some aspects, cGNSS receivers and/or antennas 1008 may support variable sampling rates, including high-rate timing output, to provide enhanced temporal resolution usable by computation components 1006 for precise alignment computation and geodetic data processing, as described herein. In some aspects, cGNSS receivers and/or antennas 1008 may be mounted to, integrated with, coupled to, or otherwise positioned in a known spatial relationship relative to the corner reflector, the monument system 110, an apex vertex reference point of the trihedral reflector, and/or another reference point of SAR corner reflector system 1000. As described herein, computation components 1006 may use the known spatial relationship, a rigid-body transformation, and/or other information described herein to relate a position of a cGNSS antenna phase center to a position of the reference point of the corner reflector.

In some configurations, communication interface 1010 may be configured to receive information from, transmit information to, and/or otherwise communicate with one or more remote systems, client systems, downstream SAR calibration, validation, or processing systems, satellite pass information sources, operator systems, maintenance systems, and/or other systems associated with SAR corner reflector system 1000. For example, communication interface 1010 may receive satellite pass information, orbital parameters, orbital ephemeris data, mission-specific ephemerides, updated pass schedules, operator-defined priority information, configuration updates, control settings, and/or other information usable by computation components 1006 to perform one or more geodetic operations. In some examples, communication interface 1010 may additionally support receipt of firmware updates, software updates, and/or other system maintenance information associated with SAR corner reflector system 1000. Additionally, or alternatively, communication interface 1010 may transmit reflector state information, verifiable state documentation, timestamped digital certificates, tamper detection records, disturbance records, alerts, system health information, quality-control information, and/or other information generated by SAR corner reflector system 1000. In some cases, communication interface 1010 may further support communication between two or more SAR corner reflector systems 1000 to enable coordinated network or array operation. In some aspects, communication interface 1010 may support one or more wired and/or wireless communication links, including cellular, satellite, direct data, Wi-Fi, Bluetooth, radio-frequency, Ethernet, optical, local-area network, wide-area network, Internet, intranet, short-range, long-range, local, regional, global, and/or other communication mechanisms, protocols, or networks, and combinations thereof.

In some instances, SAR corner reflector system 1000 may support local processing, remote processing, hybrid processing, or combinations thereof. For instance, computation components 1006 may perform time-sensitive operations locally at SAR corner reflector system 1000, including reflector state determination, self-directed alignment, closed-loop stability maintenance, tamper detection, and/or generation of verifiable state documentation, while communication interface 1010 may support remote configuration, remote monitoring, remote storage, certificate transmission, and/or downstream use of generated documentation. In some examples, a remote system receiving information from SAR corner reflector system 1000 via communication interface 1010 may perform one or more of the downstream SAR calibration, validation, or processing operations described herein, epoch-by-epoch geodetic comparisons, long-term geodetic analysis, and/or other operations associated with the verifiable state documentation and timestamped digital certificates generated by SAR corner reflector system 1000. In some configurations, SAR corner reflector system 1000 may operate autonomously when network connectivity is unavailable and may store reflector state information, verifiable state documentation, timestamped digital certificates, alerts, and/or other information locally for later transmission when communication interface 1010 establishes or reestablishes a communication link. Additionally, or alternatively, communication interface 1010 may enable real-time or near-real-time exchange of information with a remote system to update satellite pass information, receive operator instructions, transmit digital certificates, and/or coordinate one or more geodetic operations.

In some configurations, power source 1012 may be configured to provide electrical power to one or more components of SAR corner reflector system 1000, including sensing components 1002, actuation components 1004, computation components 1006, cGNSS receivers and/or antennas 1008, communication interface 1010, and/or other components described herein. For example, power source 1012 may include a battery, rechargeable battery, solar power system, solar panel, wired power connection, generator, fuel cell, energy-storage device, power-conditioning circuit, charge controller, and/or a hybrid power arrangement. In some aspects, computation components 1006 may manage power consumption by adjusting one or more of the programmable thresholds described herein, sampling rates, communication schedules, certificate transmission timing, sleep or wake states, and/or another power-management parameter associated with SAR corner reflector system 1000, such that actuator activity and other power-consuming operations may be reduced, delayed, scheduled, or initiated based on requirements of the corresponding geodetic operation. In some examples, power source 1012 may support unattended, remote, transportable, and/or field-deployed operation of SAR corner reflector system 1000 during one or more calibration operations, validation operations, monitoring operations, alignment operations, stability-maintenance operations, state-documentation operations, and/or other geodetic operations.

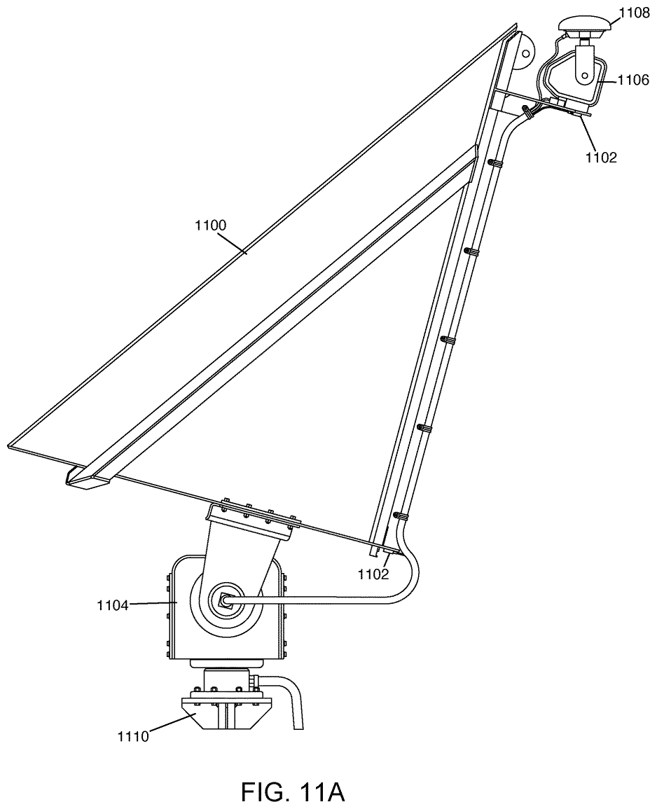

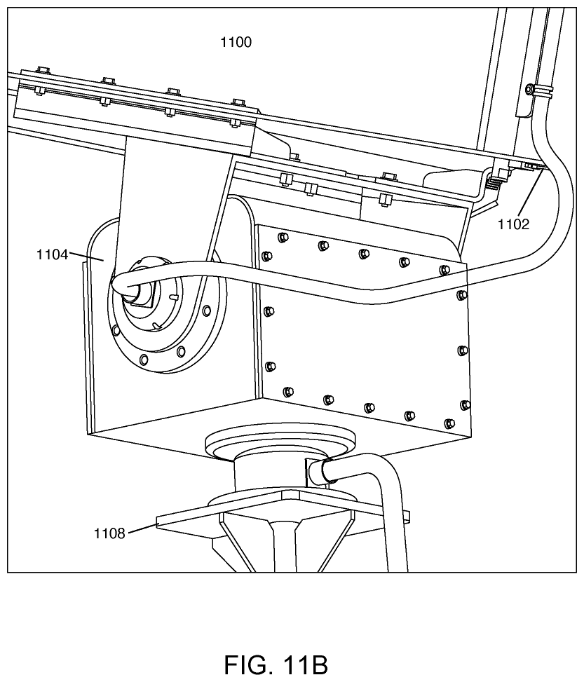

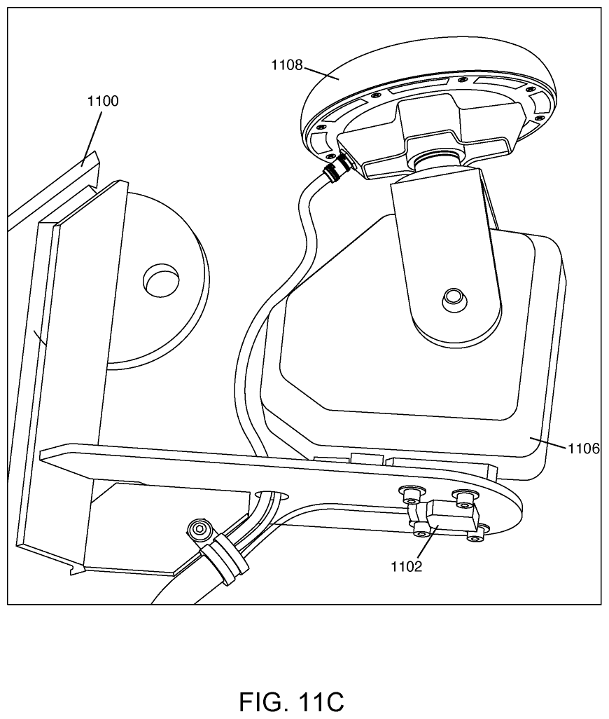

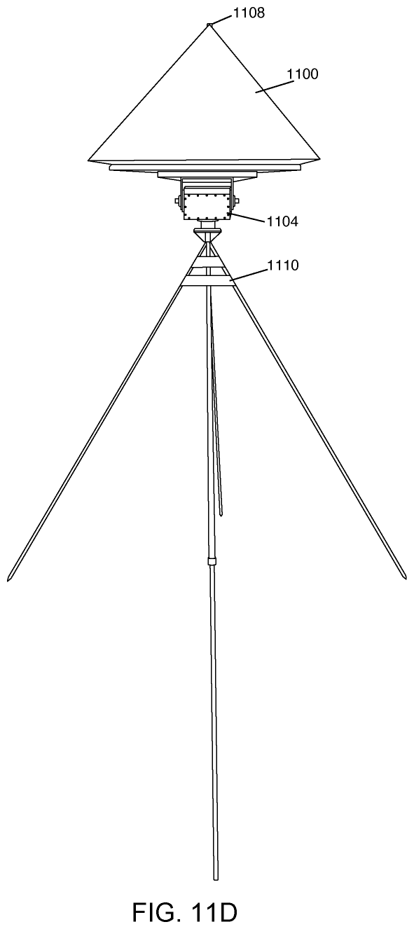

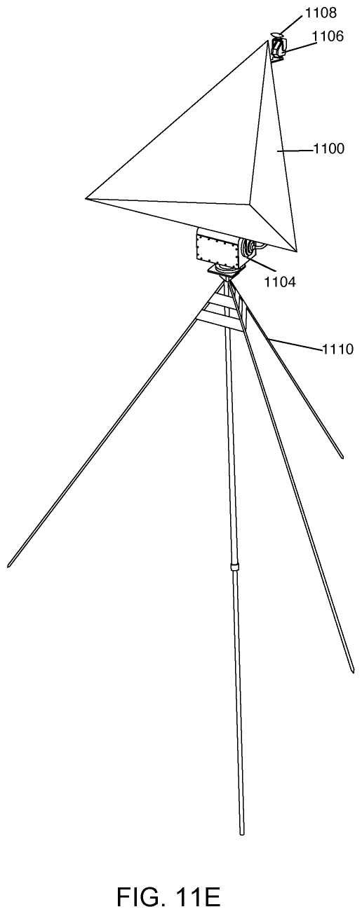

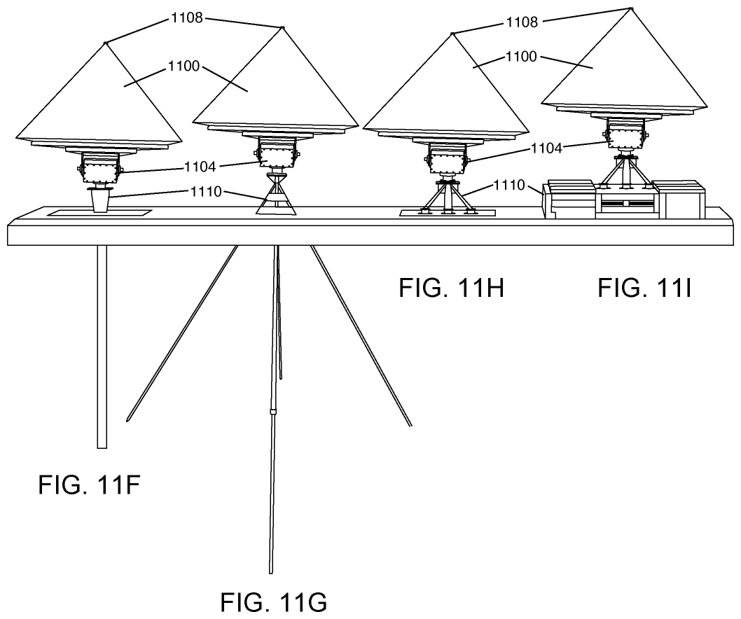

FIGS. 11A-11C illustrate example views of a corner reflector 1100, according to some aspects of the present disclosure. For example, FIG. 11A illustrates a side view of corner reflector 1100, FIG. 11B illustrates a closer view of actuation components 1104, and FIG. 11C illustrates a closer view of receiver and antenna 1108 coupled to monument system 1110. In some configurations, corner reflector 1100 may be an example implementation of SAR corner reflector system 1000 described with reference to FIG. 10 and may include one or more sensing components 1102, one or more actuation components 1104, one or more cGNSS receivers and/or antennas 1108, and/or a monument system 1110. Sensing components 1102 may be similar to sensing components 1002 described herein. Actuation components 1104 may be similar to actuation components 1004 described herein. The one or more cGNSS receivers and/or antennas 1108 may be similar to cGNSS receivers and/or antennas 1008 described herein. In some instances, FIG. 11A further illustrates an anti-tilt device associated with receiver and antenna 1108. Although not shown, corner reflector 1100 may further include one or more computation components, communication interfaces, and/or power sources, which may be similar to computation components 1006, communication interface 1010, and/or power source 1012 described herein. In some aspects, corner reflector 1100 may include cabling, power cabling, data cabling, conduit, wiring harnesses, and/or other electrical connections configured to provide power and/or communication among components of corner reflector 1100.

In some configurations, corner reflector 1100 may further include one or more computation components, communication interfaces, and/or power sources, which may be similar to computation components 1006, communication interface 1010, and/or power source 1012 described herein. Although such components may not be visible in FIG. 11A, corner reflector 1100 may include local or remote computation components configured to receive sensor data from sensing components 1102, position information and/or timing information from receiver and antenna 1108, actuation feedback from actuation components 1104, and/or other information described herein. The computation components may generate control information for actuation components 1104, coordinate self-directed alignment, coordinate closed-loop stability maintenance, coordinate an extended dwell operating mode, generate reflector state information, generate verifiable state documentation, and/or perform another geodetic operation described herein. In some aspects, corner reflector 1100 may include cabling, power cabling, data cabling, conduit, wiring harnesses, and/or other electrical connections configured to provide power and/or communication among sensing components 1102, actuation components 1104, receiver and antenna 1108, computation components, communication interfaces, power sources, and/or other components of corner reflector 1100.

In some examples, corner reflector 1100 may be coupled to, supported by, or otherwise associated with a monument system 1110, which may be similar to monument system 110 described herein. FIG. 11D illustrates a front view of corner reflector 1100, according to some aspects of the present disclosure. From the front view, receiver and antenna 1108, monument system 1110, and actuation components 1104 may be visible relative to a reflector body of corner reflector 1100. In some configurations, actuation components 1104 may support the reflector body relative to monument system 1110 and may enable an aperture, boresight direction, or other pointing axis of the reflector body to be oriented toward a target satellite, radar beam source, or corresponding line-of-sight geometry.

FIG. 11E illustrates a top-down isometric view of corner reflector 1100, according to some aspects of the present disclosure. From this view, the anti-tilt device 1106, receiver and antenna 1108, monument system 1110, and actuation components 1104 may be visible relative to the reflector body. In some aspects, the top-down isometric view may illustrate an example arrangement of receiver and antenna 1108, actuation components 1104, and monument system 1110 relative to corner reflector 1100.

FIGS. 11F-11I illustrate various example mounting configurations for mounting corner reflector 1100 to a surface or foundation 1112, according to some aspects of the present disclosure. Surface or foundation 1112 may include, without limitation, ground, soil, sediment, ice, snow, solid rock, concrete, metal, a slab, a pad, a pier, a platform, a braced foundation, a transportable foundation, a temporary field foundation, a permanent geodetic foundation, or another support surface or foundation suitable for a corresponding deployment environment. For example, FIG. 11F may illustrate a single-pipe mount design in which a stainless-steel pipe extends into rock, sediment, or another subsurface material, such as to a depth of approximately 10 feet to approximately 30 feet, and may provide a lower-cost alternative to a braced foundation and/or a configuration suitable for installation by a client or field operator. FIG. 11G may illustrate a stainless-steel braced monument foundation configured to provide geodetic-grade repeatability, in which a center leg may comprise approximately 2-inch to approximately 4-inch inside-diameter pipe and one or more braced legs may comprise approximately 1-inch solid stainless bar to approximately 2-inch pipe. In some cases, the legs of the braced monument foundation may extend approximately 10 feet to approximately 30 feet into rock, sediment, ice, tundra, or another foundation material and may be installed using augering, percussion drilling, cork-screw installation, driving, pounding, field welding, and/or another installation technique. FIG. 11H may illustrate a bolt-down mount configured to facilitate mounting corner reflector 1100 to a concrete pad or other prepared surface. FIG. 11I may illustrate a helicopter-deployable, forklift-movable, or otherwise mobile mounting system, in which ballast tanks, sandbags, rocks, or other ballast structures may be used to stabilize the system. In some aspects, the ballast tanks may house batteries, electronics, or other components, and a pallet structure of the mobile mounting system may comprise aluminum, such as 6061 aluminum, 5052 aluminum, and/or another suitable material. In some examples, the mobile mounting system may be sized and configured such that two mobile mounting systems fit within a standard cargo container.

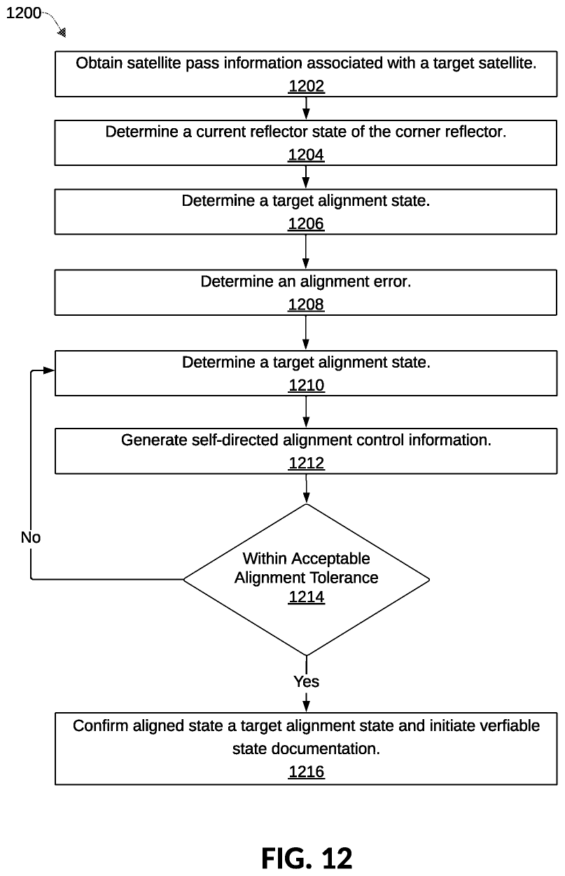

FIG. 12 is a flowchart for a method 1200 for performing self-directed alignment of a corner reflector toward a target satellite line-of-sight geometry, according to some examples of the present disclosure. Method 1200 can be performed by processing logic that can comprise hardware, software, or a combination thereof. For example, method 1200 may be performed by computation components 1006 of SAR corner reflector system 1000 described herein. It is to be appreciated that not all steps may be needed to perform the disclosure provided herein. Further, some of the steps may be performed simultaneously, repeated, or performed in a different order than shown in FIG. 12, as will be understood by a person of ordinary skill in the art.

Method 1200 shall be described with reference to FIGS. 1-10. However, method 1200 is not limited to that example. In step 1202, computation components 1006 may obtain satellite pass information associated with a target satellite. For example, computation components 1006 may obtain orbital ephemeris data, pass schedule information, look-direction geometry, and frequency-band information associated with the scheduled Sentinel-1 pass. Such information may be pre-loaded before deployment, updated periodically via communication interface 1010, or updated during routine maintenance. In some aspects, computation components 1006 may be satellite-agnostic, such that the self-directed alignment capability does not rely on live telemetry from the target satellite and may be applied to any satellite for which orbital parameters are available.

In step 1204, computation components 1006 may determine a current reflector state of the corner reflector based at least in part on sensor data from sensing components 1002, position information from cGNSS receivers and/or antennas 1008, actuation feedback from actuation components 1004, Funderpin measurements, and/or other information described herein. Continuing the example above, computation components 1006 may generate fused data from two or more of the foregoing information types and may determine the current reflector state, including, without limitation, geodetic position, reflector pose, boresight direction, and alignment state, prior to the scheduled pass.

In step 1206, computation components 1006 may determine a target alignment state for orienting the aperture of the corner reflector toward the line-of-sight geometry of the target satellite at the time of the scheduled overpass. Continuing the example above, computation components 1006 may use precise timing information from cGNSS receivers and/or antennas 1008, together with the orbital ephemeris data and scheduled overpass geometry, to determine the position and line-of-sight geometry of the Sentinel-1 satellite at the time of the overpass, and may compute the target azimuth, elevation, and other pointing parameters required to orient the reflector aperture accordingly.

In step 1208, computation components 1006 may determine an alignment error based at least in part on a comparison between the current reflector state and the target alignment state. Continuing the example above, computation components 1006 may compare the current reflector pose with the target azimuth and elevation computed for the scheduled pass, and may quantify the resulting azimuth error, elevation error, and/or other deviation between the current reflector state and the target alignment state.

In step 1210, computation components 1006 may generate self-directed alignment control information based at least in part on the alignment error, including one or more commands, setpoints, slew-rate values, and/or other control information usable by actuation components 1004 to move the corner reflector toward the target alignment state. Continuing the example above, the self-directed alignment control information may command actuation components 1004 to slew the corner reflector to the computed azimuth and elevation for the scheduled overpass of Sentinel-1.

In step 1212, actuation components 1004 may adjust the corner reflector based on the self-directed alignment control information by adjusting one or more of azimuth, elevation, tilt, and/or another positional or angular characteristic. During the slew phase, computation components 1006 may monitor updated sensor data, cGNSS information, and actuation feedback to track progress toward the target alignment state. In some aspects, the slew rate may be configurable or selectable based on the available time window, required reorientation angle, expected settling and confirmation time, and/or another operational parameter.

In step 1214, computation components 1006 may determine whether the corner reflector is aligned with the target satellite line-of-sight geometry within an acceptable alignment tolerance. Continuing the example above, following the slew phase, sensing components 1002 may provide sensor data and computation components 1006 may evaluate the fused data, reflector state information, and actuation feedback to determine whether the corner reflector is within the acceptable alignment tolerance, which may be approximately 0.001 degrees to approximately 0.1 degrees, or another tolerance suitable for the geodetic operation. If computation components 1006 determine that the corner reflector is not within the acceptable alignment tolerance, method 1200 may return to step 1210 and computation components 1006 may generate updated self-directed alignment control information to perform additional fine adjustments. Continuing the example above, this may involve generating updated commands for actuation components 1004 until the fused data confirms alignment within the acceptable tolerance. If the corner reflector is within the acceptable alignment tolerance, method 1200 may proceed to step 1216.

In step 1216, computation components 1006 may confirm an aligned state and initiate verifiable state documentation. Continuing the example above, upon confirming alignment, computation components 1006 may collect a synchronized dataset including position information from cGNSS receivers and/or antennas 1008, sensor data from sensing components 1002, actuation feedback from actuation components 1004, satellite pass information, and a UTC timestamp corresponding to the moment of alignment confirmation, and may use the synchronized dataset to generate a timestamped digital certificate documenting the geodetic position, orientation, alignment state, achieved pointing geometry, satellite identity, frequency band, and timestamp associated with the Sentinel-1 pass. Computation components 1006 may also transition actuation components 1004 from an unlocked or movable state to a locked or holding state and may maintain the corner reflector in the commanded orientation for the duration of the observation window, such as approximately 8 minutes to approximately 15 minutes per satellite pass, or another duration associated with the corresponding geodetic operation.

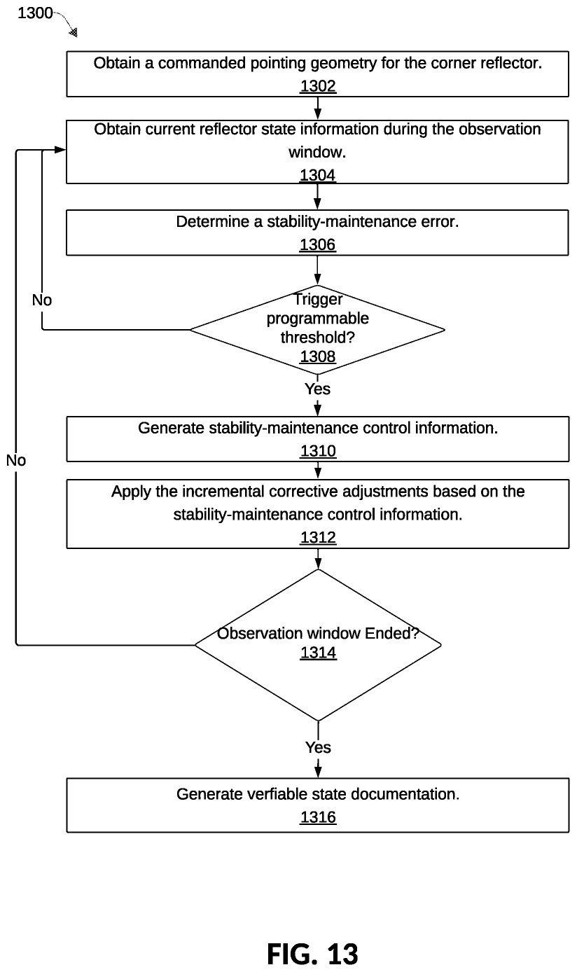

FIG. 13 is a flowchart for a method 1300 for performing closed-loop stability maintenance of a corner reflector during an observation window, according to some examples of the present disclosure. Method 1300 can be performed by processing logic that can comprise hardware, software, or a combination thereof. For example, method 1300 may be performed by computation components 1006 of SAR corner reflector system 1000 described herein. It is to be appreciated that not all steps may be needed to perform the disclosure provided herein. Further, some of the steps may be performed simultaneously, repeated, or performed in a different order than shown in FIG. 13, as will be understood by a person of ordinary skill in the art.

Method 1300 shall be described with reference to FIGS. 1-10. However, method 1300 is not limited to that example. In step 1302, computation components 1006 may obtain a commanded pointing geometry for the corner reflector. In the Sentinel-1 example, computation components 1006 may use the target alignment state computed during method 1300 as the commanded pointing geometry for the observation window, comprising the commanded azimuth, elevation, boresight direction, and other pointing parameters determined for the scheduled Sentinel-1 pass.

In step 1304, computation components 1006 may obtain current reflector state information during the observation window. In the Sentinel-1 example, sensing components 1002 may continuously sample high-rate sensor data from an IMU and/or accelerometer, including, without limitation, tilt, angular rate, vibration, acceleration, and other orientation or movement measurements, and computation components 1006 may fuse such sensor data with position information from cGNSS receivers and/or antennas 1008, actuation feedback from actuation components 1004, and other information described herein in real time to determine the current reflector state.

In step 1306, computation components 1006 may determine a stability-maintenance error based at least in part on a comparison between the current reflector state and the commanded pointing geometry. In the Sentinel-1 example, computation components 1006 may compare the current reflector state to the commanded pointing geometry to determine whether the corner reflector has drifted from the commanded orientation, and may express the stability-maintenance error as a magnitude, direction, and/or rate of change of the deviation, including azimuth error, elevation error, tilt error, and/or other deviations described herein.

In step 1308, computation components 1006 may determine whether the stability-maintenance error satisfies, exceeds, or otherwise triggers one or more programmable thresholds. In the Sentinel-1 example, computation components 1006 may compare the stability-maintenance error to an angular threshold of approximately 0.01 degrees, or another value selected for the corresponding geodetic operation. In some aspects, the one or more programmable thresholds may be configured to conserve power and reduce unnecessary actuation, such that corrective adjustments are issued only when the stability-maintenance error triggers a threshold and no motor activity is commanded when the corner reflector is already within the target tolerance. If the stability-maintenance error does not trigger the one or more programmable thresholds, method 1300 may return to step 1304 and computation components 1006 may continue monitoring the current reflector state. In the Sentinel-1 example, if the fused data indicates that the corner reflector remains within the target tolerance, computation components 1006 may continue sampling without commanding actuation components 1004 to move. If the stability-maintenance error triggers the one or more programmable thresholds, method 1300 may proceed to step 1310.

In step 1310, computation components 1006 may generate stability-maintenance control information based at least in part on the stability-maintenance error, including one or more commands, setpoints, target values, timing values, actuator-control signals, and/or other control information corresponding to one or more incremental corrective adjustments determined from the magnitude, direction, and/or rate of change of the stability-maintenance error. In the Sentinel-1 example, such corrective adjustments may include a corrective azimuth adjustment, corrective elevation adjustment, corrective tilt adjustment, and/or another adjustment usable to return the corner reflector toward the commanded pointing geometry.

In step 1312, actuation components 1004 may apply the incremental corrective adjustments based on the stability-maintenance control information. In the Sentinel-1 example, actuation components 1004 may apply the corrective adjustments to return the corner reflector toward the commanded pointing geometry, after which method 1300 may return to step 1304 and computation components 1006 may obtain updated reflector state information to determine whether the corner reflector has returned within the target tolerance. In some aspects, the correction loop may repeat at a sampling rate of sensing components 1002, such as approximately 100 Hz to approximately 800 Hz, or another rate suitable for the corresponding geodetic operation, until the observation window ends, the stability-maintenance error falls within the target tolerance, and/or another termination condition is satisfied.

In step 1314, computation components 1006 may determine whether the observation window has ended based at least in part on satellite pass information, acquisition timing information, elapsed time, a predetermined observation-window duration, a detected end of acquisition, an operator instruction, and/or another condition associated with the corresponding geodetic operation. In the Sentinel-1 example, computation components 1006 may determine whether the scheduled Sentinel-1 observation window has concluded. If the observation window has not ended, method 1300 may return to step 1304. If the observation window has ended, method 1300 may proceed to step 1316.

In step 1316, computation components 1006 may generate verifiable state documentation associated with the closed-loop stability maintenance operation. In the Sentinel-1 example, computation components 1006 may collect a synchronized dataset comprising final reflector state information, final stable orientation state, corrective adjustments applied during the observation window, orientation errors, pose deviations, threshold determinations, disturbance events, integrity-related events, actuation feedback, timestamps, and satellite pass information associated with the scheduled Sentinel-1 pass, and may use the synchronized dataset to generate a timestamped digital certificate documenting that the corner reflector was maintained within an acceptable operating condition throughout the observation window. In some aspects, if computation components 1006 determine during method 1300 that a disturbance event, integrity-related event, or tamper event has occurred, computation components 1006 may update the stability-maintenance control information, generate corrective control information, delay confirmation of a stable state, generate an alert, generate a disturbance or tamper record, and/or prevent generation of the timestamped digital certificate indicating an acceptable stable condition until the event has been resolved, cleared, or otherwise accounted for. In the Sentinel-1 example, if an impact event is detected during the observation window, computation components 1006 may generate a tamper detection record and incorporate it into the verifiable state documentation generated at the conclusion of the observation window.”

### Example Computer System

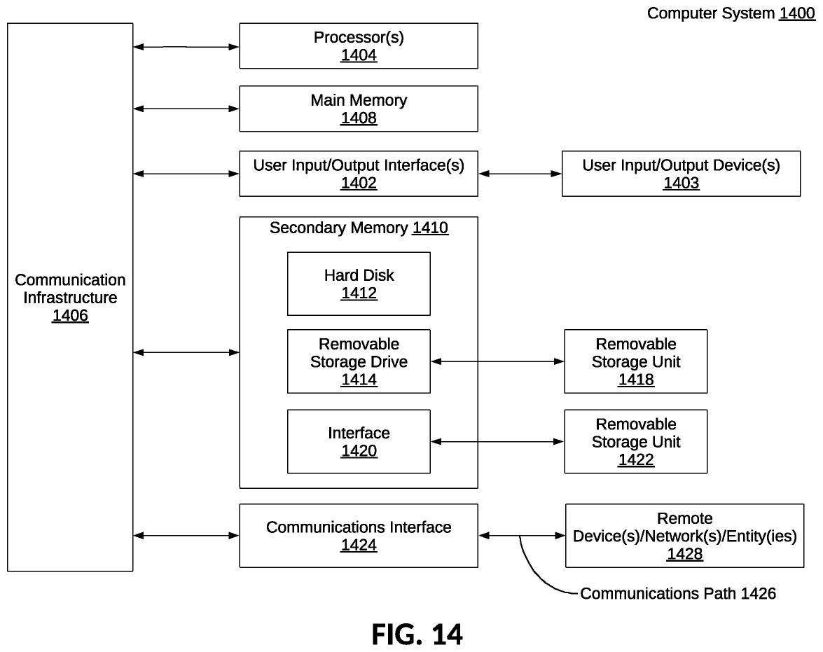

Various aspects and examples may be implemented, for example, using one or more well-known computer systems, such as computer system 1400 shown in FIG. 14. For example, the computation components 1006 may be implemented using combinations or sub-combinations of computer system 1400. Also, or alternatively, one or more computer systems 1400 may be used, for example, to implement any of the aspects and examples discussed herein, as well as combinations and sub-combinations thereof.

Computer system 1400 may include one or more processors (also called central processing units, or CPUs), such as a processor 1404. Processor 1404 may be connected to a communication infrastructure or bus 1406.

Computer system 1400 may also include user input/output device(s) 1403, such as monitors, keyboards, pointing devices, etc., which may communicate with communication infrastructure 1406 through user input/output interface(s) 1402.

One or more of processors 1404 may be a graphics processing unit (GPU). In some examples, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 1400 may also include a main or primary memory 1408, such as random-access memory (RAM). Main memory 1408 may include one or more levels of cache. Main memory 1408 may have stored therein control logic (e.g., computer software) and/or data.

Computer system 1400 may also include one or more secondary storage devices or memory 1410. Secondary memory 1410 may include, for example, a hard disk drive 1412 and/or a removable storage device or drive 1414. Removable storage drive 1414 may be a floppy disk drive, a magnetic tape drive, a compact disk drive, an optical storage device, tape backup device, and/or any other storage device/drive.

Removable storage drive 1414 may interact with a removable storage unit 1418. Removable storage unit 1418 may include a computer usable or readable storage device having stored thereon computer software (control logic) and/or data. Removable storage unit 1418 may be a floppy disk, magnetic tape, compact disk, DVD, optical storage disk, and/any other computer data storage device. Removable storage drive 1414 may read from and/or write to removable storage unit 1418.

Secondary memory 1410 may include other means, devices, components, instrumentalities or other approaches for allowing computer programs and/or other instructions and/or data to be accessed by computer system 1400. Such means, devices, components, instrumentalities or other approaches may include, for example, a removable storage unit 1422 and an interface 1420. Examples of the removable storage unit 1422 and the interface 1420 may include a program cartridge and cartridge interface (such as that found in video game devices), a removable memory chip (such as an EPROM or PROM) and associated socket, a memory stick and USB or other port, a memory card and associated memory card slot, and/or any other removable storage unit and associated interface.

Computer system 1400 may include a communication or network interface 1424. Communication interface 1424 may enable computer system 1400 to communicate and interact with any combination of external devices, external networks, external entities, etc. (individually and collectively referenced by reference number 1428). For example, communication interface 1424 may allow computer system 1400 to communicate with external or remote devices 1428 over communications path 1426, which may be wired and/or wireless (or a combination thereof), and which may include any combination of LANs, WANs, the Internet, etc. Control logic and/or data may be transmitted to and from computer system 1400 via communication path 1426.

Computer system 1400 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 1400 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 1400 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some examples, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 1400, main memory 1408, secondary memory 1410, and removable storage units 1418 and 1422, as well as tangible articles of manufacture embodying any combination of the foregoing. Such control logic, when executed by one or more data processing devices (such as computer system 1400 or processor(s) 1404), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 14. In particular, embodiments can operate with software, hardware, and/or operating system implementations other than those described herein.

### Conclusion

It is to be appreciated that the Detailed Description section, and not any other section, is intended to be used to interpret the claims. Other sections can set forth one or more, but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments but should be defined only in accordance with the following claims and their equivalents.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. A geodetic reference apparatus comprising:
a corner reflector configured for radar reflection;
a GNSS receiver coupled to the corner reflector, the GNSS receiver configured to provide positioning data, timing data or a combination thereof;
one or more sensing components coupled to the corner reflector, the one or more sensing components configured to generate sensor data indicative of one or more of an orientation, tilt, vibration, angular rate, acceleration, or dynamic motion of the corner reflector, or a combination thereof;
one or more actuation components operatively coupled to the corner reflector, the one or more actuation components configured to adjust at least one of azimuth and elevation of the corner reflector; and
a controller in communication with the GNSS receiver, the one or more sensing components, and the one or more actuation components, wherein the controller is configured to automatically control the one or more actuation components to orient the corner reflector toward a line-of-sight geometry of a target satellite without manual intervention, based at least in part on the positioning data, the timing data, the sensor data, or a combination thereof.

2. The geodetic reference apparatus of claim 1, wherein the controller is configured to orient the corner reflector based at least in part on fused data comprising one or more of the positioning data, the timing data, and the sensor data.

3. The geodetic reference apparatus of claim 1, wherein the controller is further configured to maintain the corner reflector within an acceptable alignment tolerance during an observation window by applying closed-loop corrections to the one or more actuation components based at least in part on the sensor data.

4. The geodetic reference apparatus of claim 3, wherein the closed-loop corrections are applied when a stability-maintenance error exceeds a programmable threshold.

5. The geodetic reference apparatus of claim 1, wherein orienting the corner reflector toward the line-of-sight geometry of the target satellite comprises:
obtaining satellite pass information associated with a target satellite.

6. The geodetic reference apparatus of claim 5, wherein orienting the corner reflector toward the line-of-sight geometry of the target satellite further comprises:
determining a position and line-of-sight geometry of the target satellite at a time of a scheduled overpass based on the timing data and satellite pass information associated with the target satellite;
determining a current geodetic state of the corner reflector based on the positioning data, the sensor data, or a combination thereof; and
determining a target alignment state for the corner reflector based on the position and line-of-sight geometry of the target satellite at the time of a scheduled overpass and the current geodetic state of the corner reflector.

7. The geodetic reference apparatus of claim 6, wherein orienting the corner reflector toward the line-of-sight geometry of the target satellite further comprises:
comparing the current geodetic state of the corner reflector and the target alignment state for the corner reflector;
determining an alignment error based at least in part on the comparison;
based at least in part on the alignment error, generating control information; and
providing the control information to the one or more actuation components to move the corner reflector from the current geodetic state toward the target alignment state without manual intervention.

8. The geodetic reference apparatus of claim 7, wherein orienting the corner reflector toward the line-of-sight geometry of the target satellite further comprises:
determining whether the corner reflector is within an acceptable alignment tolerance based at least in part on updated sensor data from the one or more sensing components, updated positioning data from the GNSS receiver, or a combination thereof.

9. The geodetic reference apparatus of claim 8, wherein orienting the corner reflector toward the line-of-sight geometry of the target satellite further comprises:
based on determining the corner reflector is not within the acceptable alignment tolerance, generating additional control information to cause the one or more actuation components to perform one or more additional adjustments toward the target alignment state; and
redetermining whether the corner reflector is within the acceptable alignment tolerance based at least in part on the updated sensor data, updated positioning data, or a combination thereof.

10. The geodetic reference apparatus of claim 8, wherein orienting the corner reflector toward the line-of-sight geometry of the target satellite further comprises:
based on determining the corner reflector is within the acceptable alignment tolerance, maintaining the corner reflector within the acceptable alignment tolerance during an observation window associated with the target satellite.

11. The geodetic reference apparatus of claim 10, wherein maintaining the corner reflector within the acceptable alignment tolerance during the observation window comprises:
monitoring sensor data from the one or more sensing components during the observation window;
fusing the sensor data with the positioning data, the timing data, or a combination thereof to generate fused data;
determining a current reflector state of the corner reflector based on the fused data;
comparing the current reflector state to the target alignment state; and
determining a stability-maintenance error based on the comparison, the stability-maintenance error representing a deviation between the current reflector state and the target alignment state.

12. The geodetic reference apparatus of claim 11, wherein maintaining the corner reflector within the acceptable alignment tolerance during the observation window further comprises:
generating stability-maintenance control information when the stability-maintenance error exceeds or otherwise triggers one or more programmable thresholds, the stability-maintenance control information comprising one or more commands configured to cause the one or more actuation components to apply incremental corrective adjustments to return the corner reflector toward the target alignment state; and
providing the stability-maintenance control information to the one or more actuation components, wherein the one or more programmable thresholds are configurable to reduce actuation activity when the stability-maintenance error is within the acceptable alignment tolerance.

13. The geodetic reference apparatus of claim 1, wherein the corner reflector comprises a trihedral reflector, the trihedral reflector comprising a plurality of vertices.

14. The geodetic reference apparatus of claim 13, further comprising:
a geodetic-grade braced foundation; and
one or more survey pins attached to one or more of the plurality of vertices, wherein each of the one or more survey pins comprises a recess configured for engagement by a survey instrument and defines a survey reference point configured to facilitate direct survey measurements of the corner reflector.

15. A method comprising:
obtaining, from one or more sensing components, sensor data indicative of one or more of an orientation, tilt, vibration, angular rate, acceleration, or dynamic motion of a corner reflector, or a combination thereof;
obtaining, from a GNSS receiver, positioning data, timing data, or a combination thereof associated with the corner reflector;
obtaining satellite pass information associated with a target satellite;
determining a target alignment state for the corner reflector based at least in part on the positioning data, the timing data, the sensor data, or a combination thereof, and the satellite pass information associated with the target satellite; and
automatically controlling one or more actuation components operatively coupled to the corner reflector to orient the corner reflector toward a line-of-sight geometry of the target satellite based at least in part on the target alignment state, without manual intervention.

16. The method of claim 15, further comprising:
determining a positioning and line-of-sight geometry of the target satellite at a time of a scheduled overpass based at least in part on the timing data and the satellite pass information associated with the target satellite;
determining a current geodetic state of the corner reflector based at least in part on the positioning data, the sensor data, or a combination thereof; and
determining the target alignment state for the corner reflector based at least in part on the positioning and line-of-sight geometry of the target satellite at the time of the scheduled overpass and the current geodetic state of the corner reflector.

17. The method of claim 16, further comprising:
comparing the current geodetic state of the corner reflector and the target alignment state;
determining an alignment error based at least on the comparison;
generating control information based at least in part on the alignment error, the control information configured to cause the one or more actuation components to move the corner reflector from the current geodetic state toward the target alignment state; and
providing the control information to the one or more actuation components to move the corner reflector toward the target alignment state without manual intervention.

18. The method of claim 17, further comprising:
determining whether the corner reflector is within an acceptable alignment tolerance based at least in part on updated sensor data from the one or more sensing components, updated positioning data from the GNSS receiver, or a combination thereof.

19. The method of claim 18, further comprising:
based on determining the corner reflector is within the acceptable alignment tolerance, maintaining the corner reflector within the acceptable alignment tolerance during an observation window associated with the target satellite, wherein maintaining comprises:
monitoring sensor data from the one or more sensing components during the observation window;
fusing the sensor data with the positioning data, the timing data, or a combination thereof to generate fused data;
determining a current reflector state of the corner reflector based at least in part on the fused data;
comparing the current reflector state to the target alignment state; and
determining a stability-maintenance error based at least in part on the comparison, the stability-maintenance error representing a deviation between the current reflector state and the target alignment state.

20. A non-transitory computer-readable medium having instructions stored thereon that, when executed by at least one computing device associated with a corner reflector, cause the at least one computing device to perform operations comprising:
obtaining, from one or more sensing components, sensor data indicative of one or more of an orientation, tilt, vibration, angular rate, acceleration, or dynamic motion of a corner reflector, or a combination thereof;
obtaining, from a GNSS receiver, positioning data, timing data, or a combination thereof associated with the corner reflector;
obtaining satellite pass information associated with a target satellite;
determining a target alignment state for the corner reflector based at least in part on the positioning data, the timing data, the sensor data, or a combination thereof, and the satellite pass information associated with the target satellite; and
automatically controlling one or more actuation components operatively coupled to the corner reflector to orient the corner reflector toward a line-of-sight geometry of the target satellite based at least in part on the target alignment state, without manual intervention.
